(19) United States
(12) Patent Application Publication
(10) Pub. No.: US 2009/0237492 A1
(43) Pub. Date: Sep. 24, 2009

(54) ENHANCED STEREOSCOPIC IMMERSIVE VIDEO RECORDING AND VIEWING

(75) Inventors: Dan Kikinis, Saratoga, CA (US); Meher Gourjian, Oakland, CA (US); Rajesh Krishnan, San Francisco, CA (US); Russel H. Phelps, III, Highlands Ranch, CO (US); Richard Schmidt, Highlands Ranch, CO (US); Stephen Weyl, Los Altos Hills, CA (US)

Correspondence Address: FENWICK & WEST LLP, SILICON VALLEY CENTER, 801 CALIFORNIA STREET, MOUNTAIN VIEW, CA, 94041, US

(73) Assignee: INVISM, INC., Greenwood, CO (US)

(21) Appl. No.: 12/405,957

(22) Filed: Mar. 17, 2009

Related U.S. Application Data
(60) Provisional application No. 61/037,643, filed on Mar. 18, 2008.
(60) Provisional application No. 61/060,422, filed on Jun. 10, 2008.
(60) Provisional application No. 61/092,608, filed on Aug. 28, 2008.
(60) Provisional application No. 61/093,649, filed on Sep. 2, 2008.
(60) Provisional application No. 61/110,788, filed on Nov. 3, 2008.
(60) Provisional application No. 61/150,944, filed on Feb. 9, 2009.

(51) Int. Cl. H04N 13/02

(52) U.S. Cl. 348/47; 348/46; 348/E13.074; 348/E13.075

(57) ABSTRACT

An immersive audio-visual system (and a method) for creating an enhanced interactive and immersive audio-visual environment is disclosed. The immersive audio-visual environment enables participants to enjoy true interactive, immersive audio-visual reality experience in a variety of applications. The immersive audio-visual system comprises an immersive video system, an immersive audio system and an immersive audio-visual production system. The video system creates immersive stereoscopic videos that mix live videos, computer generated graphic images and human interactions with the system. The immersive audio system creates immersive sounds with each sound resource positioned correct with respect to the position of an associated participant in a video scene. The immersive audio-video production system produces an enhanced immersive audio and videos based on the generated immersive stereoscopic videos and immersive sounds. A variety of applications are enabled by the immersive audio-visual production including casino-type interactive gaming system and training system.

### RELATED APPLICATIONS

This application claims priority under 35 U.S.C. §119(e) to U.S. Provisional Patent Application No. 61/037,643, filed on Mar. 18, 2008, entitled “SYSTEM AND METHOD FOR RAISING CULTURAL AWARENESS” which is incorporated by reference in its entirety. This application also claims priority under 35 U.S.C. §119(e) to U.S. Provisional Patent Application No. 61/060,422, filed on Jun. 10, 2008, entitled “ENHANCED SYSTEM AND METHOD FOR STEREOSCOPIC IMMERSIVE ENVIRONMENT AND SIMULATION” which is incorporated by reference in its entirety. This application also claims priority under 35 U.S.C. §119(e) to U.S. Provisional Patent Application No. 61/092,608, filed on Aug. 28, 2008, entitled “SYSTEM AND METHOD FOR PRODUCING IMMERSIVE SOUNDSCAPES” which is incorporated by reference in its entirety. This application also claims priority under 35 U.S.C. §119(e) to U.S. Provisional Patent Application No. 61/093,649, filed on Sep. 2, 2008, entitled “ENHANCED IMMERSIVE RECORDING AND VIEWING TECHNOLOGY” which is incorporated by reference in its entirety. This application also claims priority under 35 U.S.C. §119(e) to U.S. Provisional Patent Application No. 61/110,788, filed on Nov. 3, 2008, entitled “ENHANCED APPARATUS AND METHODS FOR IMMERSIVE VIRTUAL REALITY” which is incorporated by reference in its entirety. This application also claims priority under 35 U.S.C. §119(e) to U.S. Provisional Patent Application No. 61/150,944, filed on Feb. 9, 2009, entitled “SYSTEM AND METHOD FOR INTEGRATION OF INTERACTIVE GAME SLOT WITH SERVING PERSONNEL IN A LEISURE- OR CASINO-TYPE ENVIRONMENT WITH ENHANCED WORK FLOW MANAGEMENT” which is incorporated by reference in its entirety. This application is related to U.S. application Ser. No. ______, entitled “ENHANCED IMMERSIVE SOUNDSCAPES PRODUCTION”, Attorney Docket No. 26989-15334, filed on and U.S. application Ser. No. ______, entitled “INTERACTIVE IMMERSIVE VIRTUAL REALITY AND SIMULATION”, Attorney Docket No. 26989-15336, filed on ______, which are hereby incorporated by reference.

### BACKGROUND OF THE INVENTION

1. Field of the Invention

The invention relates generally to creating an immersive virtual reality environment. Particularly, the invention relates to an enhanced interactive, immersive audio-visual production and simulation system which provides an enhanced immersive stereoscopic virtual reality experience for participants.

2. Description of the Background Art

An immersive virtual reality environment refers to a computer-simulated environment with which a participant is able to interact. The wide field of vision, combined with sophisticated audio, creates a feeling of “being physically” or cognitively within the environment. Therefore, an immersive virtual reality environment creates an illusion to a participant that he/she is in an artificially created environment through the use of three-dimensional (3D) graphics and computer software which imitates the relationship between the participant and the surrounding environment. Currently existing virtual reality environments are primarily visual experiences, displayed either on a computer screen or through special or stereoscopic displays. However, currently existing immersive stereoscopic systems have several disadvantages in terms of immersive stereoscopic virtual reality experience for participants.

The first challenge is concerned with immersive video recording and viewing. An immersive video generally refers to a video recoding of a real world scene, where a view in every direction is recorded at the same time. The real world scene is recorded as data which can be played back through a computer player. During playing back by the computer player, a viewer can control viewing direction and playback speed. One of main problems in current immersive video recording is limited field of view because only one view direction (i.e., the view toward a recording camera) can be used in the recording.

Alternatively, existing immersive stereoscopic systems use 360-degree lenses mounted on a camera. However, when 360-degree lenses are used, the resolution, especially at the bottom end of display, which is traditionally compressed to a small number of pixels in the center of the camera, is very fuzzy even if using a camera with a resolution beyond that of high-definition TV (HDTV). Additionally, such cameras are difficult to adapt for true stereoscopic vision, since they have only a single vantage point. It is very improbable to have two of these cameras next to each other because the cameras would block a substantial fraction of each other's view. Thus, it is difficult to create a true immersive stereoscopic video recording system using such camera configurations.

Another challenge is concerned with immersive audio recording. Immersive audio recording allows a participant to hear a realistic audio mix of multiple sound resources, real or virtual, in its audible range. The term “virtual” sound source refers to an apparent source of a sound, as perceived by the participant. A virtual sound source is distinct from actual sound sources, such as microphones and loudspeakers. Instead of presenting a listener (e.g., an online gamer) a wall of sound (stereo) or an incomplete surround experience, the goal of immersive sound is to present a listener a much more convincing sound experience.

Although some visual devices can take in video information and use, for example, accelerometers to position the vision field correctly, often immersive sound is not processed correctly or with optimization. Thus, although an immersive video system may correctly record the movement of objects in a scene, a corresponding immersive audio system may not perceive a changing object correctly synchronized with the sound associated with it. As a result, a participant of a current immersive audio-visual environment may not have a full virtual reality experience.

With the advent of 3D surround video, one of the challenges is offering commensurate sound. However, even high-resolution video today has only a 5-plus-1 or 7-plus-1 sound and is only good for camera viewpoint. In immersive virtual reality environments, such as in 3D video games, the sound often is not adapted to the correct position of the sound source since the correct position may be the normal camera position for viewing on a display screen with surround sound. In immersive interactive virtual reality environment, the correct sound position changes following a participant's movements in both direction and location for interactions. Existing immersive stereoscopic systems often fail to automatically generate immersive sound from a sound source positioned correctly relative to the position of a participant who also listens.

Compounding these challenges faced by existing immersive stereoscopic systems, images used in immersive video are often purely computer-generated imagery. Objects in computer-generated images are often limited to movements or interactions predetermined by some computer software. These limitations result in disconnect between the real world recorded and the immersive virtual reality. For example, the resulting immersive stereoscopic systems often lack details of facial expression of a performer being recorded, and a true look-and-feel high-resolution all-around vision.

Challenges faced by existing immersive stereoscopic systems further limit their applications to a variety of application fields. One interesting application is interactive casino-type gaming. Casinos and other entertainment venues need to come up with novel ideas to capture people's imaginations and to entice people to participate in activities. However, even the latest and most appealing video slot machines fail to fully satisfy players and casino needs. Such needs include the need to support culturally tuned entertainment, to lock a player's experience to a specific casino, to truly individualize entertainment, to fully leverage resources unique to a casino, to tie in revenue from casino shops and services, to connect players socially, to immerse players, and to enthrall the short attention spans of players of the digital generation.

Another application is interactive training system to raise awareness of cultural differences. When people travel to other countries it is often important for them to understand differences between their own culture and the culture of their destination. Certain gestures or facial expressions can have different meanings and implications in different cultures. For example, nodding one's head (up and down) means “yes” in some cultures and “no” in others. For another example, holding one's thumb out asks for a ride, while in other cultures, it is a lewd and insulting gesture that may put the maker in some jeopardy.

Such awareness of cultural differences is particularly important for military personnel stationed in countries of a different culture. Due to the large turnover of people in and out of a military deployment, it is often a difficult task to keep all personnel properly trained regarding local cultural differences. Without proper training, misunderstandings can quickly escalate, leading to alienation of local population and to public disturbances including property damage, injuries and even loss of life.

Hence, there is, inter alia, a lack of a system and method that creates an enhanced interactive and immersive audio-visual environment where participants can enjoy true interactive, immersive audio-visual virtual reality experience in a variety of applications.

### SUMMARY OF THE INVENTION

The invention overcomes the deficiencies and limitations of the prior art by providing a system and method for creating immersive stereoscopic videos that combine live videos, computer-generated images and human interactions with the system. In one embodiment, the immersive video system comprises a background scene creation module, an immersive video scene creation module, a command module and a video rendering module. The background scene creation module is configured to create a background scene for an immersive stereoscopic video. The immersive video scene creation module is configured to record a plurality of immersive video scenes using the background scene and a plurality of the cameras and microphones. An immersive video scene may comprise a plurality of participants and immersion tools such as immersive visors and cybergloves. The command module is configured to create or receive one or more interaction instructions for the immersive stereoscopic videos. The video rendering module is configured to render the plurality of the immersive videos scenes and to produce the immersive stereoscopic videos for multiple video formats.

### BRIEF DESCRIPTION OF THE DRAWINGS

The invention is illustrated by way of example, and not by way of limitation in the figures of the accompanying drawings in which like reference numerals are used to refer to similar elements.

FIG. 1 is a high-level block diagram illustrating a functional view of an immersive audio-visual production and simulation environment according to one embodiment of the invention.

FIG. 2 is a block diagram illustrating a functional view of an immersive video system according to one embodiment of the invention.

FIG. 3A is a block diagram illustrating a scene background creation module of an immersive video system according to one embodiment of the invention.

FIG. 3B is a block diagram illustrating a video scene creation module of an immersive video system according to one embodiment of the invention.

FIG. 4 is a block diagram illustrating a view selection module of an immersive video system according to one embodiment of the invention.

FIG. 5 is a block diagram illustrating a video scene rendering engine of an immersive video system according to one embodiment of the invention.

FIG. 6 is a flowchart illustrating a functional view of immersive video creation according to one embodiment of the invention.

FIG. 7 is an exemplary view of an immersive video playback system according to one embodiment of the invention.

FIG. 8 is a functional block diagram showing an example of an immersive video playback engine according to one embodiment of the invention.

FIG. 9 is an exemplary view of an immersive video session according to one embodiment of the invention.

FIG. 10 is a functional block diagram showing an example of a stereoscopic vision module according to one embodiment of the invention.

FIG. 11 is an exemplary pseudo 3D view over a virtual surface using the stereoscopic vision module illustrated in FIG. 10 according to one embodiment of the invention.

FIG. 12 is a functional block diagram showing an example of an immersive audio-visual recording system according to one embodiment of the invention.

FIG. 13 is an exemplary view of an immersive video scene texture map according to one embodiment of the invention.

FIG. 14 is an exemplary view of an exemplary immersive audio processing according to one embodiment of the invention.

FIG. 15 is an exemplary view of an immersive sound texture map according to one embodiment of the invention.

FIG. 16 is a flowchart illustrating a functional view of immersive audio-visual production according to one embodiment of the invention.

FIG. 17 is an exemplary screen of an immersive video editing tool according to one embodiment of the invention

FIG. 18 is an exemplary screen of an immersive video scene playback for editing according to one embodiment of the invention

FIG. 19 is a flowchart illustrating a functional view of applying the immersive audio-visual production to an interactive training process according to one embodiment of the invention.

FIG. 20 is an exemplary view of an immersive video recording set according to one embodiment of the invention.

FIG. 21 is an exemplary immersive video scene view field according to one embodiment of the invention.

FIG. 22A is an exemplary super fisheye camera for immersive video recoding according to one embodiment of the invention.

FIG. 22B is an exemplary camera lens configuration for immersive video recording according to one embodiment of the invention.

FIG. 23 is an exemplary immersive video viewing system using multiple cameras according to one embodiment of the invention.

FIG. 24 is an exemplary immersion device for immersive video viewing according to one embodiment of the invention.

FIG. 25 is another exemplary immersion device for the immersive audio-visual system according to one embodiment of the invention.

FIG. 26 is a block diagram illustrating an interactive casino-type gaming system according to one embodiment of the invention.

FIG. 27 is an exemplary slot machine device of the casino-type gaming system according to one embodiment of the invention.

FIG. 28 is an exemplary wireless interactive device of the casino-type gaming system according to one embodiment of the invention.

FIG. 29 is a flowchart illustrating a functional view of interactive casino-type gaming system according to one embodiment of the invention.

FIG. 30 is an interactive training system using immersive audio-visual production according to one embodiment of the invention.

FIG. 31 is a flowchart illustrating a functional view of interactive training system according to one embodiment of the invention.

### DETAILED DESCRIPTION OF THE PREFERRED EMBODIMENTS

A system and method for an enhanced interactive and immersive audio-visual production and simulation environment is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. For example, the invention is described in one embodiment below with reference to user interfaces and particular hardware. However, the invention applies to any type of computing device that can receive data and commands, and any peripheral devices providing services.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the invention is not described with reference to any particular programming language. It will be appreciated that a variety of programming languages may be used to implement the teachings of the invention as described herein.

### System Overview

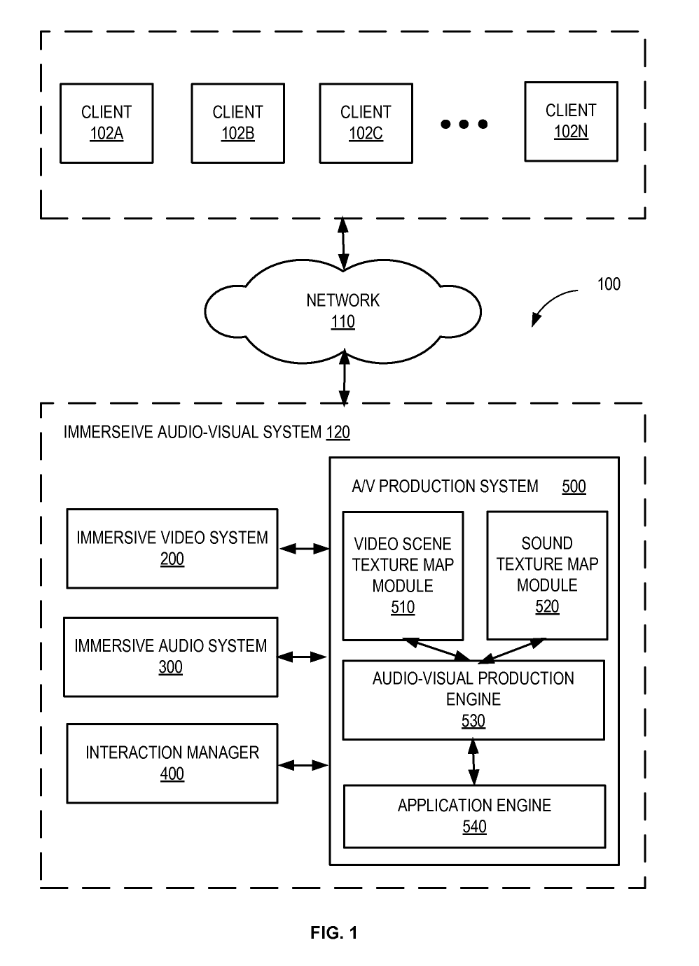

FIG. 1 is a high-level block diagram illustrating a functional view of an immersive audio-visual production and simulation environment 100 according to one embodiment of the invention. The illustrated embodiment of the immersive audio-visual production and simulation environment 100 includes multiple clients 102A-N and an immersive audio-visual system 120. In the illustrated embodiment, the clients 102 and the immersive audio-visual system 120 is communicatively coupled via a network 190. The environment 100 in FIG. 1 is used only by way of example.

Turning now to the individual entities illustrated in FIG. 1, the client 102 is used by a participant to interact with the immersive audio-visual system 120. In one embodiment, the client 102 is a handheld device that displays multiple views of an immersive audio-visual recording from the immersive audio-visual system 120. In other embodiments, the client 102 is a mobile telephone, personal digital assistant, or other electronic device, for example, an iPod Touch or an iPhone with a global positioning system (GPS) that has computing resources for remote live previewing of an immersive audio-visual recording. In some embodiments, the client 102 includes a local storage, such as a hard drive or flash memory device, in which the client 102 stores data used by a user in performing tasks.

In one embodiment of the invention, the network 110 is a partially public or a globally public network such as the Internet. The network 110 can also be a private network or include one or more distinct or logical private networks (e.g., virtual private networks or wide area networks). Additionally, the communication links to and from the network 110 can be wire line or wireless (i.e., terrestrial- or satellite-based transceivers). In one embodiment of the invention, the network 110 is an IP-based wide or metropolitan area network.

The immersive audio-visual system 120 is a computer system that creates an enhanced interactive and immersive audio-visual environment where participants can enjoy true interactive, immersive audio-visual virtual reality experience in a variety of applications. In the illustrated embodiment, the audio-visual system 120 comprises an immersive video system 200, an immersive audio system 300, an interaction manager 400 and an audio-visual production system 500. The video system 200, the audio system 300 and the interaction manager 400 are communicatively coupled with the audio-video production system 500. The immersive audio-visual system 120 in FIG. 1 is used only by way of example. The immersive audio-visual system 120 in other embodiments may include other subsystems and/or functional modules.

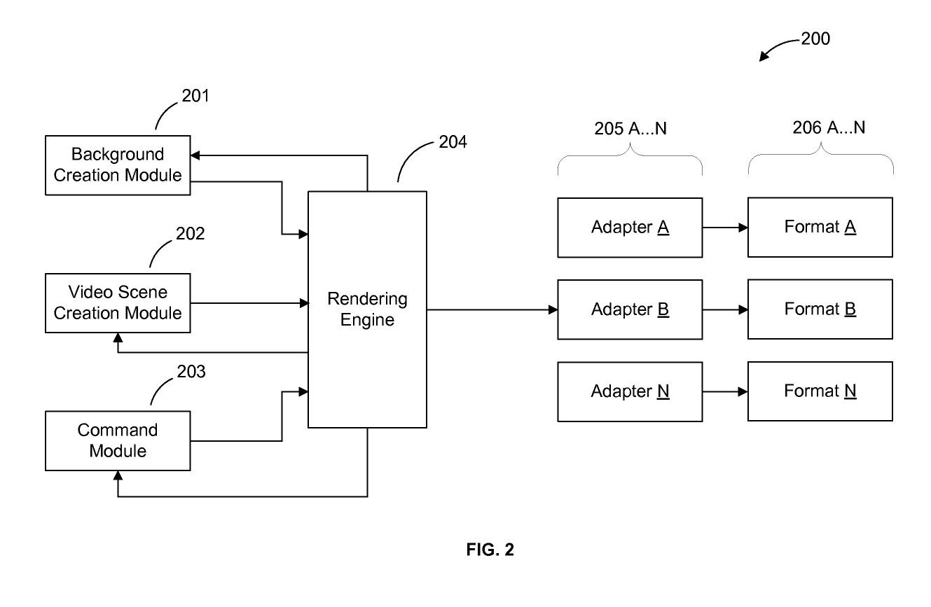

The immersive video system 200 creates immersive stereoscopic videos that mix live videos, computer generated graphic images and interactions between a participant and recorded video scenes. The immersive videos created by the video system 200 are further processed by the audio-visual production system 500. The immersive video system 200 is further described with reference to FIGS. 2-11.

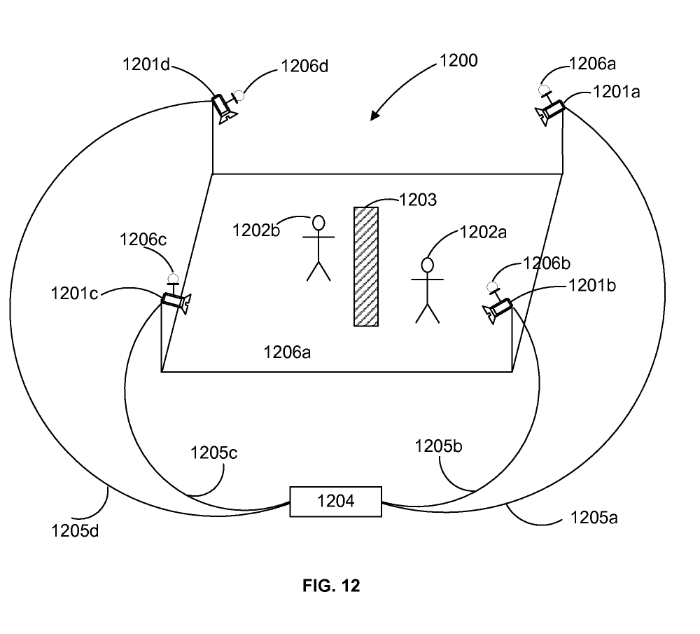

The immersive audio system 300 creates immersive sounds with sound resources positioned correctly relative to the position of a participant. The immersive sounds created by the audio system 300 are further processed by the audio-visual system 500. The immersive audio system 300 is further described with reference to FIGS. 12-16.

The interaction manager 400 typically monitors the interactions between a participant and created immersive audio-video scenes in one embodiment. In another embodiment, the interaction manager 400 creates interaction commands for further processing the immersive sounds and videos by the audio-visual production system 500. In yet anther embodiment, the interaction manager 400 processes service requests from the clients 102 and determines types of applications and their simulation environment for the audio-visual production system 500.

The audio-visual system 500 receives immersive videos from the immersive video system 200, the immersive sounds from the immersive audio system 300 and the interaction commands from the interaction manager 400 and produces an enhanced immersive audio and videos, with which participants can enjoy true interactive, immersive audio-visual virtual reality experience in a variety of applications. The audio-visual production system 500 includes a video scene texture map module 510, a sound texture map module 520, an audio-visual production engine 530 and an application engine 540. The video scene texture map module 510 creates a video texture map where video objects in an immersive video scene are represented with better resolution and quality than, for example, typical CGI or CGV of faces etc. The sound texture map module 520 accurately calculates sound location in an immersive sound recording. The audio-visual production engine 530 reconciles the immersive videos and audios to accurately match the video and audio sources in the recorded audio-visual scenes. The application engine 540 enables post-production viewing and editing with respect to the type of application and other factors for a variety of applications, such as online intelligent gaming, military training simulations, cultural-awareness training, and casino-type of interactive gaming.

### Immersive Video Recording

FIG. 2 is a block diagram illustrating a functional view of an immersive video system 200, such as the one illustrated in FIG. 1, according to one embodiment of the invention. The video system 200 comprises a scene background creation module 201, a video scene creation module 202, a command module 203 and a video rendering engine 204. The immersive video system 200 further comprises a plurality of resource adapters 205A-N and a plurality of videos in different formats 206A-N.

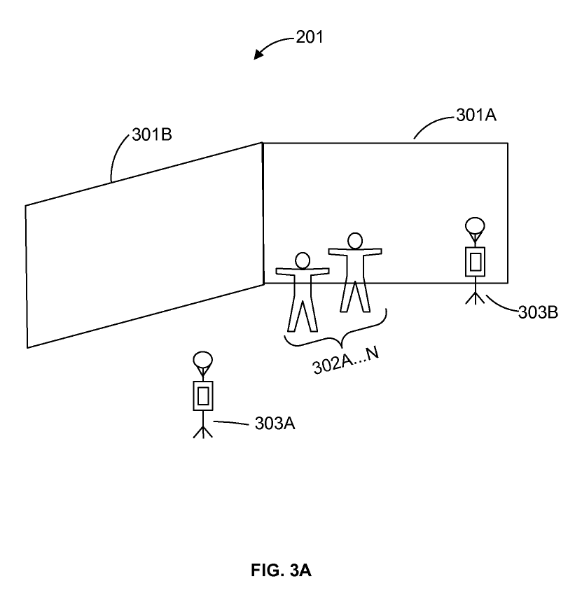

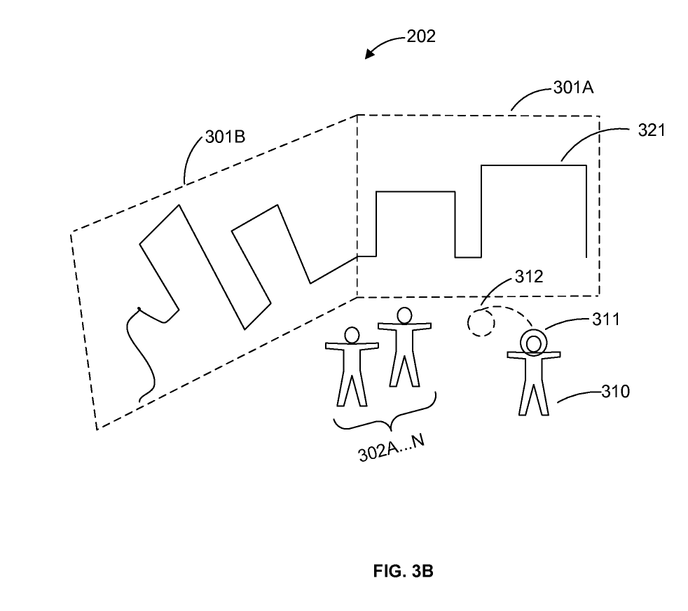

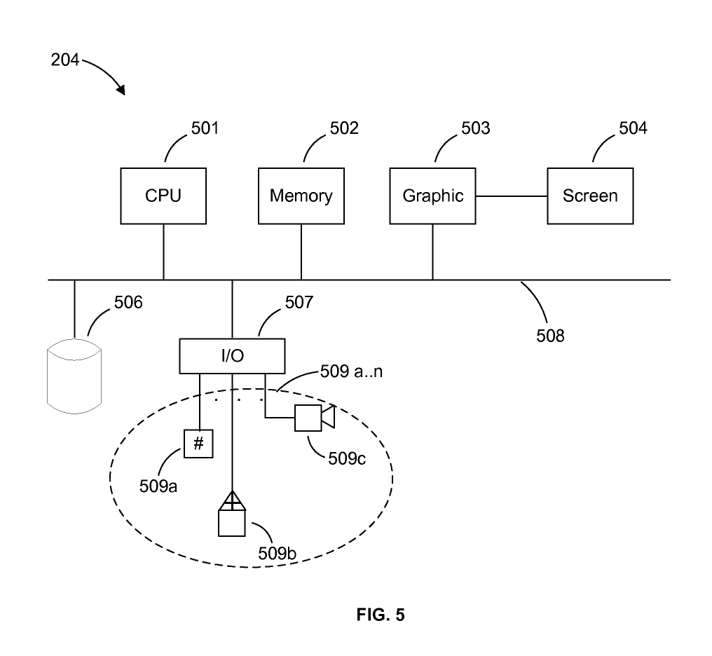

The scene background creation module 201 creates a background of an immersive video recording, such as static furnishings or background landscape of a video scene to be recorded. The video scene creation module 202 captures video components in a video scene using a plurality of cameras. The command module 203 creates command scripts and directs the interactions among a plurality of components during recoding. The scene background and captured video objects and interaction commands are rendered by the video rendering engine 204. The scene background creation module 201, the video scene creation module 202 and the video rendering engine 204 are described in more detail below with reference to FIGS. 3A, 3B and FIG. 5, respectively.

Various formats 206a-n of a rendered immersive video are delivered to next processing unit (e.g., the audio-visual production system 500 in FIG. 1) through the resource adapters 205A-N. For example, some formats 206 may be highly interactive (e.g., including emotion facial expressions of a performer being captured) using high-performance systems with real-time rendering. In other cases, a simplified version of the rendered immersive video may simply have a number of video clips with verbal or textual interaction of captured video objects. These simplified versions may be used on more computing resource limited systems, such as a hand-held computer. An intermediate version may be appropriate for use on a desktop or laptop computer, and other computing systems.

Embodiments of the invention include one or more resource adapters 205 for a created immersive video. A resource adapter 205 receives an immersive video from the rendering engine 204 and modifies the immersive video according to different formats to be used by a variety of computing systems. Although the resource adapters 205 are shown as a single functional block, they may be implemented in any combination of modules or as a single module running on the same system. The resource adapters 205 may physically reside on any hardware in the network, and since they may be provided as distinct functional modules, they may reside on different pieces of hardware. If in portions, some or all of the resource adapters 205 may be embedded with hardware, such as on a client device in the form of embedded software or firmware within a mobile communications handset. In addition, other resource adapters 205 may be implemented in software running on general purpose computing and/or network devices. Accordingly, any or all of the resource adapters 205 may be implemented with software, firmware, or hardware modules, or any combination of the three.

FIG. 3A is a block diagram illustrating a scene background creation module 201 of the immersive video system 200 according to one embodiment of the invention. In the illustrated embodiment, the scene background creation module 201 illustrates a video recoding studio where scene background is created. The scene background creation module 201 comprises two blue screens 301A-B as a recording background, a plurality of actors/performers 302A-N in front of the blue screen 301A and a plurality of cameras 303. In another embodiment, the scene background creation module 201 may include more blue screens 301 and one or more static furnishings as part of the recording background. Other embodiments may also include a computer-generated video of a background, set furnishings and/or peripheral virtual participants. Only two actors 302 and two cameras 303A-B are shown in the illustrated embodiment for purposes of clarity and simplicity. Other embodiments may include more actors 302 and cameras 303.

In one embodiment, the camera 303a-n are a special high-definition (HD) cameras that have one or more 360-degree lenses for 360-degree panoramic view. The special HD cameras allow a user to record a scene from various angles at a specified frame rate (e.g., 30 frames per second). Photos (i.e., static images) from the recoded scene can be extracted and stitched together to create images at high resolution, such as 1920 by 1080 pixels. Any suitable scene stitching algorithms can be used within the system described herein. Other embodiments may use other types of cameras for the recording.

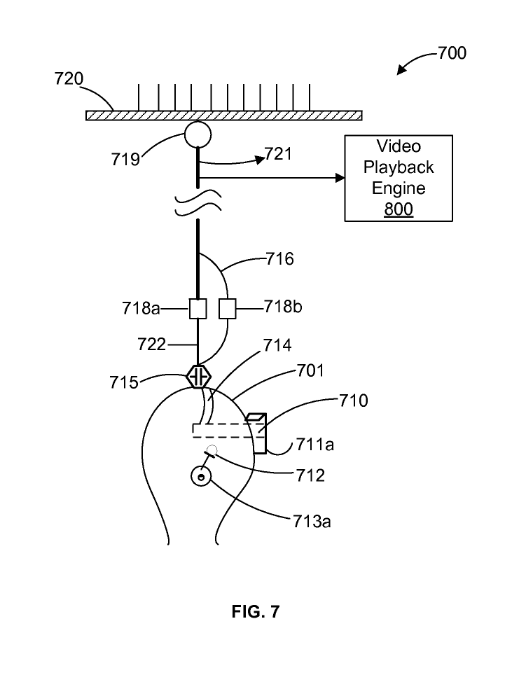

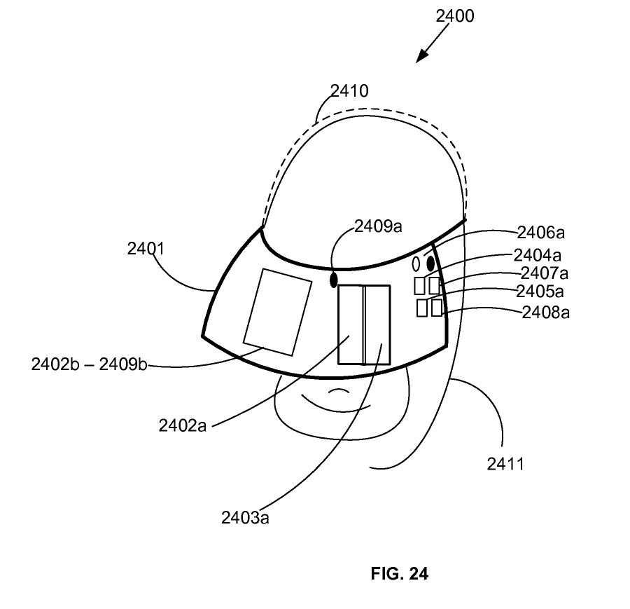

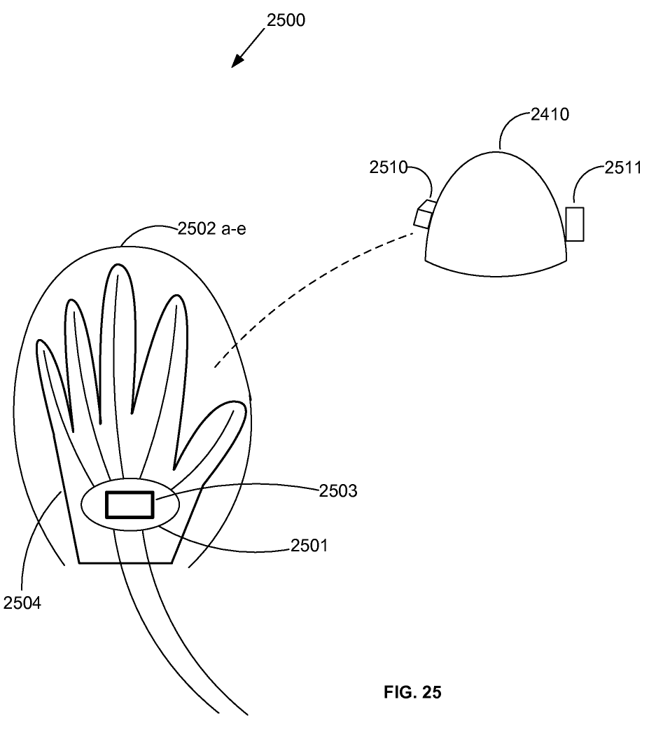

FIG. 3B is a block diagram illustrating a video scene creation module 202 of the immersive video system 200 according to one embodiment of the invention. In the illustrated embodiment, the video scene creation module 202 is set for a virtual reality training game recording. The blue screens 301A-B of FIG. 3A are replaced by a simulated background 321 which can be an image of a village or houses as shown in the illustrated embodiment. The actors 302A-N appear now as virtual participants in their positions, and the person 310 participating in the training game wears a virtual reality helmet 311 with a holding object 312 to interact with the virtual participants 302A-N and objects in the video scene. The holding object 312 is a hand-held input device such as a keypad, or cyberglove. The holding object 312 is used to simulate a variety of objects such as a gift, a weapon, or a tool. The holding object 312 as a cyberglove is further described below with reference to FIG. 25. The virtual reality helmet 311 is further described below with reference to FIGS. 7 and 24.

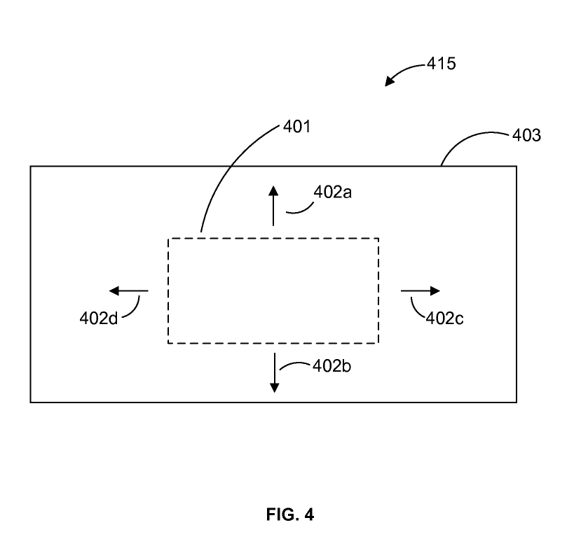

In the virtual reality training game recording illustrated in FIG. 3B, participant 310 can turn his/her head and see video in his/her virtual reality helmet 311. His/her view field represents, for example, a subsection of the view that he/she would see in a real life situation. In one embodiment, this view subsection can be rendered or generated by using individual views of the video recoded by cameras 303A-B (not shown here for clarity), or a computer-generated video of a background image, set furnishings and peripheral virtual participants. Other embodiments include a composite view made by stitching together multiple views from a recorded video, a computer-generated video and other view resources. The views may contain 3D objects, geometry, viewpoint, texture, lighting and shading information. View selection is further described below with reference to FIG. 4.

FIG. 4 is a block diagram illustrating a view selection module 415 of the immersive video system 200 according to one embodiment of the invention. The view selection module 415 comprises a HD resolution image 403 to be processed. Image 403 may be an actual HD TV resolution video recorded in the field, or a composite one stitched together from multiple views by cameras, or a computer-generated video, or any combination generated from the above. The HD image 403 may also include changing virtual angles generated by using a stitched-together video from multiple HD cameras. The changing virtual angles of the HD image 403 allow reuse of certain shots for different purposes and application scenarios. In a highly interactive setting, the viewing angle may be computer-generated at the time of interaction between a participant and the recorded video scene. In other cases, it is done post-production (recording) and prior to interaction.

Image 401 shows a view subsection selected from the image 403 and viewed in the virtual reality helmet 311. The view subsection 401 is a subset of HD resolution image 403 with a smaller video resolution (e.g., a standard definition resolution). In one embodiment, the view subsection 401 is selected in response to the motion of the participant's headgear, such as the virtual reality helmet 311 worn by the participant 310 in FIG. 3B. The view subsection 401 is moved within the full view of the image 403 in different directions 402a-d, and is adjusted to allow the participant to see different sections of the image 403. In some cases, if the HD image 403 is non-linearly recorded or generated, for example using a 360 degree or super fisheye lens, a corrective distortion may be required to correct the image 403 into a normal view.

FIG. 5 is a block diagram illustrating a video scene rendering engine 204 of the immersive video system 200 according to one embodiment of the invention. The term “rendering” refers to a process of calculating effects in a video recording file to produce a final video output. Specifically, the video rendering engine 204 receives views from the scene background creation module 201 and views (e.g., videos) from the video scene creation module 202, and generates an image or scene by means of computer programs based on the received views and interaction commands from the command module 203. Various methodologies for video rendering, such as radiosity using finite element mathematics, are known, all of which are within the scope of the invention.

In the embodiment illustrated in FIG. 5, the video rendering engine 204 comprises a central processing unit (CPU) 501, a memory 502, a graphics system 503, and a video output device 504 such as a dual screen of a pair of goggles, or a projector screen, or a standard display screen of a personal computer (PC). The video rendering engine 204 also comprises a hard disk 506, an I/O subsystem 507 with interaction devices 509a-n, such as keyboard 509a, pointing device 509b, speaker/microphone 509c, and other devices 509 (not shown in FIG. 5 for purposes of simplicity). All these components are connected and communicating with each other via a computer bus 508. While shown as software stored in the disk 506 and running on a general purpose computing, those skilled in the art will recognize that in other embodiments, the video rendering engine 204 may be implemented as hardware. Accordingly, the video rendering engine 204 may be implemented with software, firmware, or hardware modules, depending on the design of the immersive video system 200.

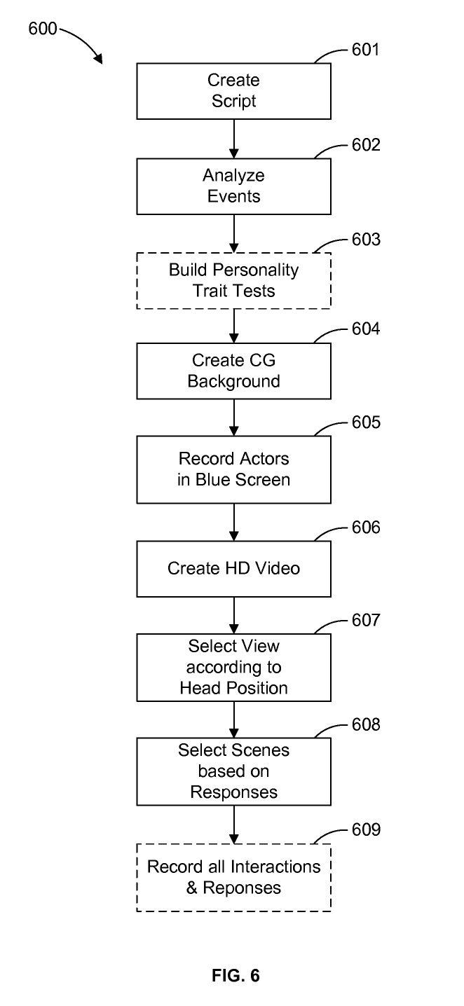

FIG. 6 is a flowchart illustrating a functional view of immersive video creation according to one embodiment of the invention. Initially, a script is created 601 by a video recording director via the command module 203. In one embodiment, the script is a computer program in a format as a “wizard”. In step 602, the events in of the script are analyzed by the command module 203. In step 603 (as an optional step), personality trait tests are built and are distributed throughout the script. In step 604, a computer-generated background is created suitable for the scenes according to the script by the scene background creation module 201. In step 605, actors are recorded by the video scene creation module 202 in front of a blue screen or an augmented blue screen to create video scenes according to the production instructions of the script. In step 607, HD videos of the recorded scenes are created by the video rendering engine 204. Multiple HD videos may be stitched together to create a super HD or to include multiple viewing angles. In step 608, views are selected for display in goggles (e.g., the virtual reality helmet 311 in FIG. 3A) in an interactive format, according to the participant's head position and movements. In step 609, various scenes are selected corresponding to various anticipated responses of the participant. In step 610, a complete recording of all the interactions is generated.

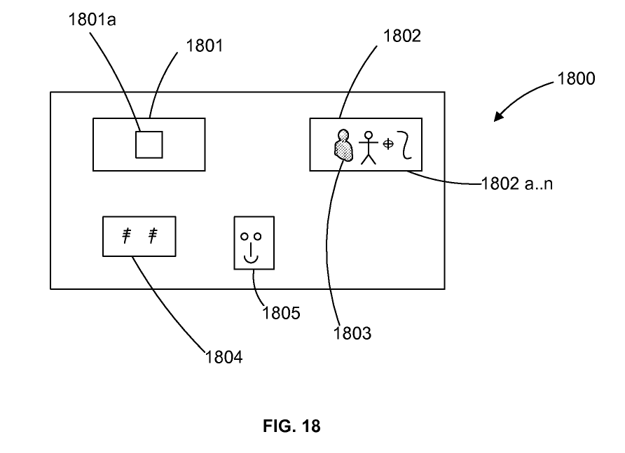

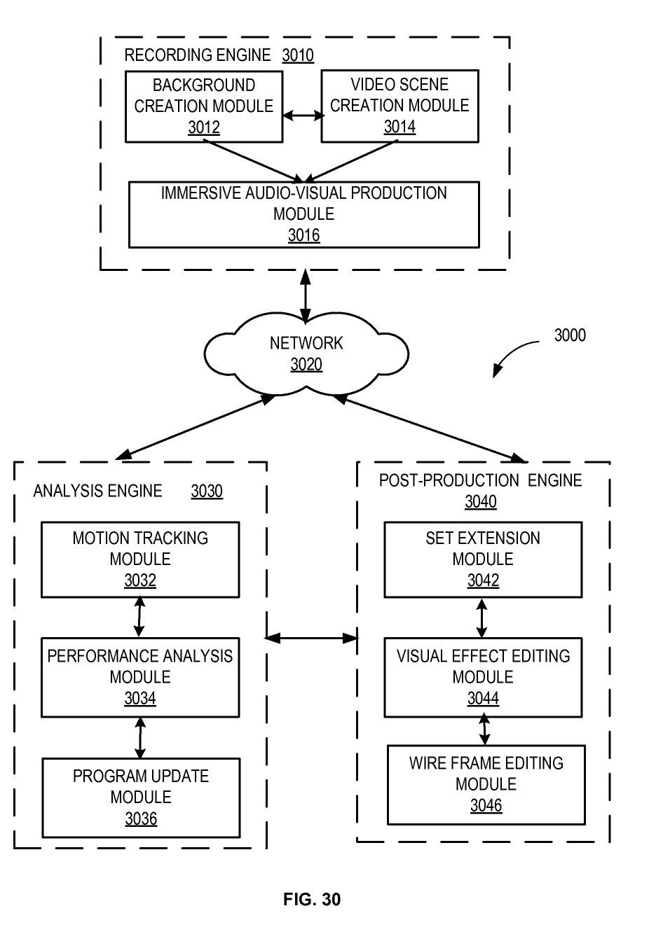

The immersive video creation process illustrated in FIG. 6 contains two optional steps, step 603 for building personality trait tests and step 609 for recording all interactions and responses. The personality trait tests can be built for applications, such as military training simulations and cultural-awareness training applications, entertainment, virtual adventure travels and etc. Military training simulations and cultural-awareness training applications are further described below with reference to FIGS. 18-19 and FIGS. 30-31. The complete recording of all the interactions can be used for various applications by a performance analysis module 3034 of FIG. 30. For example, the complete recording of all the interactions can be used for performance review and analysis of individual or a group of participants by a training manager in military training simulations and cultural-awareness training applications.

### Immersive Video Playback

FIG. 7 is an exemplary view of an immersive video playback system 700 according to one embodiment of the invention. The video playback system 700 comprises a head assembly 710 worn on a participant's head 701. In the embodiment illustrated in FIG. 7, the head assembly 710 comprises two glass screens 711a and 711b (screen 711b not shown for purposes of simplicity). The head assembly 710 also has a band 714 going over the head of the participant. A motion sensor 715 is attached to the head assembly 710 to monitor head movements of the participant. A wire or wire harness 716 is attached to the assembly 710 to send and receive signals from the screens 711a and 711b, or from a headset 713a (e.g., a full ear cover or an earbud) (The other side 713b is not shown for purposes of simplicity), and/or from a microphone 712. In other embodiments, the head assembly 710 can be integrated into some helmet-type gear that has a visor similar to a protective helmet with a pull-down visor, or to a pilot's helmet, or to a motorcycle helmet. An exemplary visor is further described below with reference to FIGS. 24 and 25.

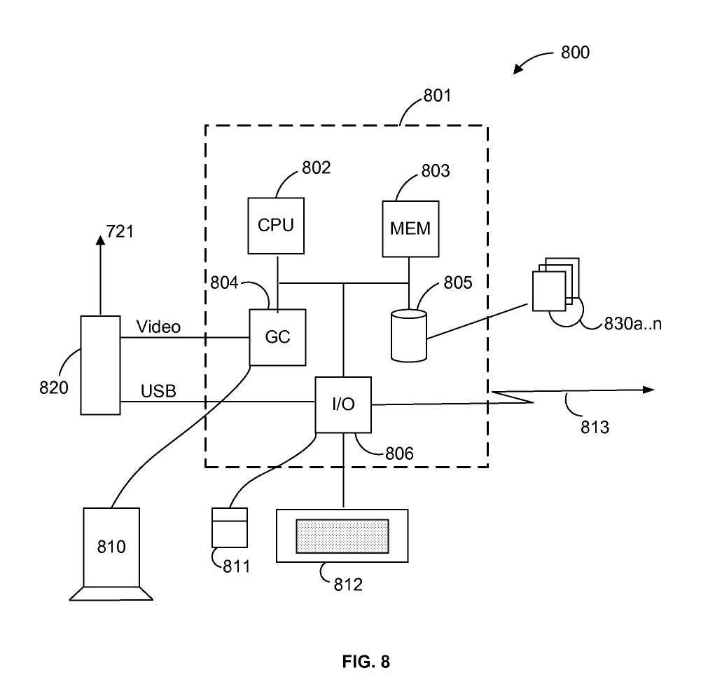

In one embodiment, for example, a tether 722 is attached to the head assembly 710 to relieve the participant from the weight of the head assembly 710. The video playback system 700 also comprises one or more safety features. For example, the video playback system 700 include two break-away connections 718a and 718b so that communication cables easily get separated without any damage to the head assembly 710 or without strangling the participant in a case where the participant jerks his/her head, falls down, faints, or puts undue stress on the overhead cable 721. The overhead cable 721 connects to a video playback engine 800 to be described below with reference to FIG. 8.

To further reduce tension or weight caused by using the head assembly 710, the video playback system 700 may also comprise a tension- or weight-relief mechanism 719 that provides virtually zero weight of the head assembly 710 to the participant. The tension relief is attached to a mechanical device 720 that can be a beam above the simulation area, or the ceiling, or some other form of overhead support. In one embodiment, noise cancellation is provided by the playback system 700 to reduce local noises so that the participant can focus on sounds and deliberated added noises of audio, video or audio-visual immersion.

FIG. 8 is a functional block diagram showing an example of an immersive video playback engine 800 according to one embodiment of the invention. The video playback engine 800 is communicated coupled with the head assembly 710 described above, processes the information from the head assembly 710 and plays back the video scenes viewed by the head assembly 710.

The playback engine 800 comprises a central computing unit 801. The central computing unit 801 contains a CPU 802, which has access to a memory 803 and to a hard disk 805. The hard disk 805 stores various computer programs 830a-n to be used for video playback operations. In one embodiment, the computer programs 830a-n are for both an operating system of the central computing unit 801 and for controlling various aspects of the playback system 700. The playback operations comprise operations for stereoscopic vision, binaural stereoscopic sound and other immersive audio-visual production aspects. An I/O unit 806 connects to a keyboard 812 and a mouse 811. A graphics card 804 connects to an interface box 820, which drives the head assembly 710 through the cable 721. The graphics card 804 also connects to a local monitor 810. In other embodiments, the local monitor 810 may not be present.

The interface box 820 is mainly a wiring unit, but it may contain additional circuitry connected through a USB port to the I/O unit 806. Connections to external I/O source 813 may also be used in other embodiments. For example, the motion sensor 715, the microphone 712, and the head assembly 710 may be driven as USB devices via said connections. Additional security features may also be a part of the playback engine 800. For example, an iris scanner may get connected with the playback engine 800 through the USB port. In one embodiment, the interface box 820 may contain a USB hub (not shown) so that more devices may be connected to the playback engine 800. In other embodiments, the USB hub may be integrated into the head assembly 710, head band 714, or some other appropriate parts of the video playback system 700.

In one embodiment, the central computing unit 801 is built like a ruggedized video game player or game console system. In another embodiment, the central computing unit 801 is configured to operate with a virtual camera during post-production editing. The virtual camera uses video texture mapping to select virtual video that can be used on a dumb player and the selected virtual video can be displayed on a field unit, a PDA, or handheld device.

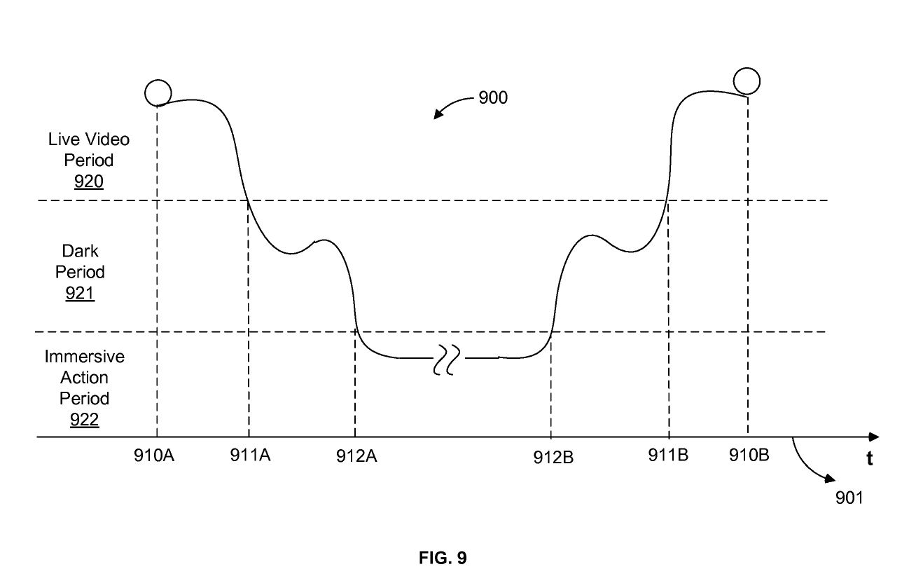

FIG. 9 is an exemplary view of an immersive video session 900 over a time axis 901 according to one embodiment of the invention. In this example, a “soft start-soft end” sequence has been added, which is described below, but may or may not be used in some embodiments. When a participant puts on the head assembly 710 initially at time point 910A, the participant may see, for example, a live video that can come from some small cameras mounted on the head assembly 710, or just a white screen of a recording studio. At the time point 911A, the video image slowly changes into a dark screen. At time point 912A, the session enters an immersive action period, where the participant interacts with the recorded view through an immersion device, such as a mouse or other sensing devices.

The time period between the time point 910A and time point 911A is called live video period 920. The time period between the time point 911A and time point 912A is called dark period, and the time period between the time point 912A and the time point when the session ends is called immersive action period 922. When the session ends, the steps are reversed with the corresponding time periods 910B, 911B and 912B. The release out of the immersive action period 922, in one embodiment, is triggered by some activity in the recording studio, such as a person shouting at the participant, or a person walking into the activity field, which can be protected by laser, or by infrared scanner, or by some other optic or sonic means. The exemplary immersive video session described in FIG. 9 in other embodiments is not limited to video. It can be applied to immersive sound sessions to be described below in details.

### Immersive Stereoscopic Visions

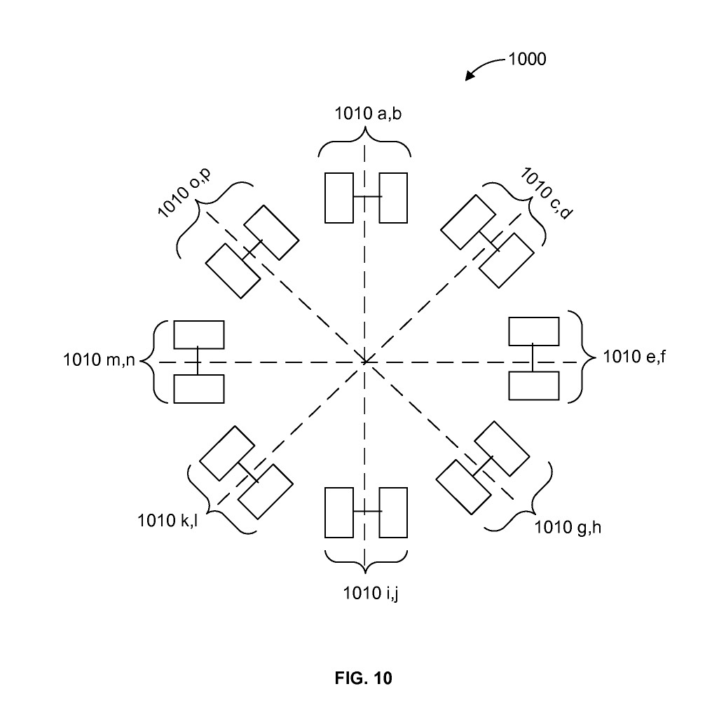

FIG. 10 is a functional block diagram showing an example of a stereoscopic vision module 1000 according to one embodiment of the invention. The stereoscopic vision module 1000 provides optimized immersive stereoscopic visions. A stereoscopic vision is a technique capable of recording 3D visual information or creating the illusion of depth in an image. Traditionally, the 3D depth information of an image can be reconstructed from two images using a computer by matching the pixels in the two images. To provide stereo images, two different images can be displayed to different eyes, where images can be recorded using multiple cameras in pairs. Cameras can be configured to be above each other, or in two circles next to each other, or sideways offset. To be most accurate, camera pairs should be next to each other with 3.5″ next to each other to simulate eyes, or for distance. To allow more flexible camera setups, virtual cameras can be used together with actual cameras. To solve camera alignment issues while filming, a camera jig can be used one meter square with multiple beacons. The stereoscopic vision module 1000 illustrated in FIG. 10 provides an optimized immersive stereoscopic vision through a novel cameras configuration, a dioctographer (a word to define a camera assembly that records 2×8 views) configuration.

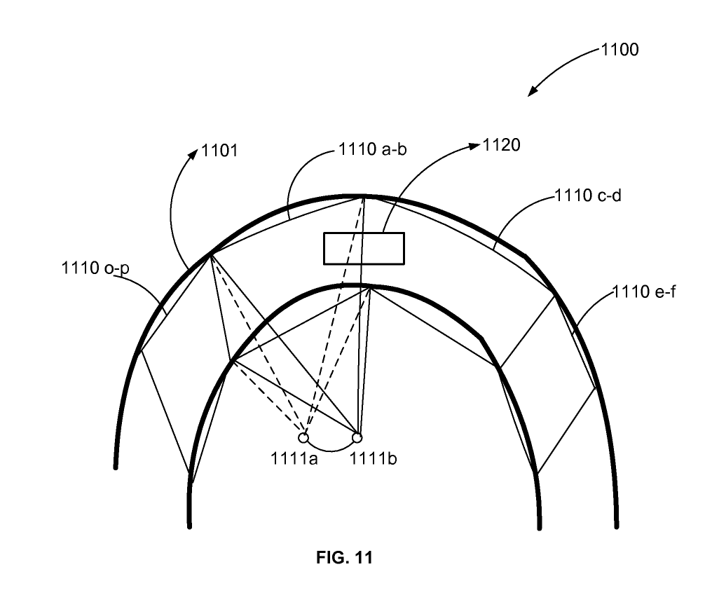

The embodiment illustrated in FIG. 10 comprises eight pairs of cameras 1010a,b-1010o,p mounted on a plate to record 2 by 8 views. The eight pairs of the cameras 1010a,b-1010o,p are positioned apart from each other. Each of the cameras 1010 can also have one or two microphones to provide directional sound recording from that particular point of view, which can be processed using binaural directional technology that is known to those of ordinary skills in the art. The signals (video and/or sound) from these cameras 1010 are further processed and combined to create immersive audio-visual scenes. In one embodiment, the platform holding the cameras 1010 together is a metal plate to which the cameras are affixed with some bolts. This type of metal plate-camera framework is well known in camera technology. In other embodiments, the whole cameras-plate assembly is attached with a “shoe,” which is also well known in camera technology, or to a body balancing system, a so-called “steady cam.” In yet another embodiment, the camera assembly may attach to a helmet in such a way that the cameras 1010 sit at eye-level of the camera man. There may be many other ways to mount and hold the cameras 1010, none of which depart from the broader spirit and scope of the invention. The stereoscopic vision module 1000 is further described with reference to FIG. 11. The immersive audio-visual scene production using the dioctographer configuration is further described below with reference to FIGS. 12-16.

The stereoscopic vision module 1000 can correct software inaccuracies. For example, the stereoscopic vision module 1000 uses an error detecting software to detect an audio and video mismatch. If audio data says one location and video data says completely different location, the software detects the problem. In cases where a nonreality artistic mode is desired, the stereoscopic vision module 1000 can flag video frames to indicate that typical reality settings for filming are being bypassed.

A camera 1010 in the stereoscopic vision module 1000 can have its own telemetry, GPS or similar system with accuracies of up to 0.5″. In another embodiment, a 3.5″ camera distance between a pair of cameras 1010 can be used for sub-optimal artistic purposes and/or subtle/dramatic 3D effects. During recording and videotaping, actors can carry an infrared, GPS, motion sensor or RFID beacon around, with a second set of cameras or RF triangulation/communications for tracking those beacons. Such configuration allows recording, creation of virtual camera positions and creation of the viewpoints of the actors. In one embodiment, with multiple cameras 1010 around a shooting set, lower resolution follows a tracking device and position can be tracked. Alternatively, an actor can have an IR device that gives location information. In yet another embodiment, a web camera can be used to see what the actor sees when they move from virtual camera point of view (POV).

The stereoscopic vision module 1000 can be a wearable piece, either as a helmet, or as add-on to a steady cam. During playback with the enhanced reality helmet-cam, telemetry like the above beacon systems can be used to track what a participant was looking at, allowing a recording instructor or coach to see real locations from the point of view of the participant.

Responsive to the need of better camera mobility, the stereoscopic vision module 1000 can be put into multiple rigs. To help recording directors shoot better, one or more monitors will allow them to see a reduced-resolution or full-resolution version of the camera view(s), which transform to unwrapping in real-time video in multiple angles. In one embodiment, a virtual camera in a 3-D virtual space can be used to guide the cutting with reference to the virtual camera position. In another embodiment, the stereoscopic vision module 1000 uses mechanized arrays of cameras 1010, so each video frame can have a different geometry. To help move heavy cameras around, a motorized assist can have a throttle that cut out at levels that are believed to upset the camera array/placement/configuration/alignment.

FIG. 11 is an exemplary pseudo 3D view 1100 over a virtual surface using the stereoscopic vision module 1000 illustrated in FIG. 10 according to one embodiment of the invention. The virtual surface 1101 is a surface onto which a recorded video is projected or textured-bound (i.e., treating image data as texture in the stereoscopic view). Since each camera pair, such as 1010a,b, has its own viewpoint, the projection happens from a virtual camera position 1111a,b onto virtual screen sections 1110a-b, 1110c-d, 1110e-f, etc. In one embodiment, an octagonal set of eight virtual screen sections (1110a-b through 1110o-p) is organized within a cylindrical arrangement of the virtual surface 1101. By using only a cylindrical shape, far less distortion is introduced during projection. Point 1120 is the virtual position of the head assembly 710 on the virtual surface 1101 based on the measurement by an accelerometer. For this plane, stereoscopic spaces 1110a,b and 1110c,d can be stitched to provide a correct stereoscopic vision for the virtual point 1120, allowing a participant to turn his/her head 360 degrees and receive correct stereoscopic information.

### Immersive Audio-Visual Recording System

FIG. 12 shows an exemplary immersive audio-visual recording system 1200 according to one embodiment of the current invention. The embodiment illustrated in FIG. 12 comprises two actors 1202a and 1202b, an object of an exemplary column 1203, four cameras 1201a-d and an audio-visual processing system 1204 to record both video and sound from each of the cameras 1201. Each of the cameras 1201 also has one or more stereo microphones 1206. Only four cameras 1201 are illustrated in FIG. 12. Other embodiments can include dozens even hundreds of cameras 1201. Only one microphone 1206 is attached with the camera 1201 in the illustrated embodiment. In other embodiments, two or more stereo microphones 1206 can be attached to a camera 1201. Communications connections 1205a-d connect the audio-visual processing system 1204 to the cameras 1201a-d and their microphones 1206a-d. The communications connections 1205a-d can be wired connections, analog or digital, or wireless connections.

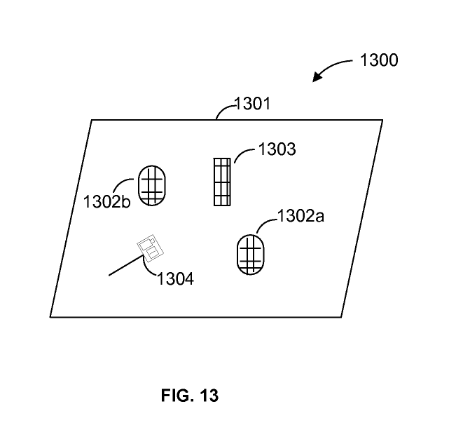

The audio-visual processing system 1204 processes the recorded audio and video with image processing and computer vision techniques to generate an approximate 3D model of the video scene. The 3D model is used to generate a view-dependent texture mapped image to simulate an image seen from a virtual camera. The audio-visual processing system 1204 also accurately calculates the location of the sound from a target object by analyzing one or more of the latency and delays and phase shift of received sound waves from different sound sources. The audio-visual recoding system 1024 maintains absolute time synchronicity between the cameras 1201 and the microphones 1206. This synchronicity permits an enhanced analysis of the sound as it is happening during recording. The audio-visual recoding system and time synchronicity feature are further described in details below with reference to FIGS. 13-15.

FIG. 13 show an exemplary model of a video scene texture map 1300 according to one aspect of the invention. Texture mapping is a method for adding detail, surface texture or color to a computer-generated graphic or 3D model. Texture mapping is commonly used in video game consoles and computer graphics adapters which store special images used for texture mapping and apply the stored texture images to each polygon of an object in a video scene on the fly. The video scene texture map 1300 in FIG. 13 illustrates a novel use of known texture mapping techniques and the video scene texture map 1300 can be further utilized to provide enhanced immersive audio-visual production described in details throughout the entire specification of the invention.

The texture map 1300 illustrated in FIG. 13 represents a view-dependent texture mapped image corresponding to the image used in FIG. 12 viewed from a virtual camera. The texture map 1300 comprises the texture-mapped actors 1302a and 1302b and a texture-mapped column 1303. The texture map 1300 also comprises a position of a virtual camera 1304 positioned in the texture map. The virtual camera 1304 can look at objects (e.g., the actors 1302 and the column 1303) from different positions, for example, in the middle of screen 1301. Only one virtual camera 1304 is illustrated in FIG. 13. The more virtual cameras 1304 are used during the recording phase, as shown in FIG. 12, the better the resolution of objects is to be represented in the texture map 1300. In addition, the plurality of virtual cameras 1304 used during the recording phase is good for solving problems such as hidden angles. For example, if the recording set is crowded, it is very difficult to get the full texture of each actor 1202, because some view sections of some actors 1202 are not captured by any camera 1201. The plurality of virtual cameras 1304 in conjunction with software with a fill-in algorithm can be used together to fill in the missing view sections.

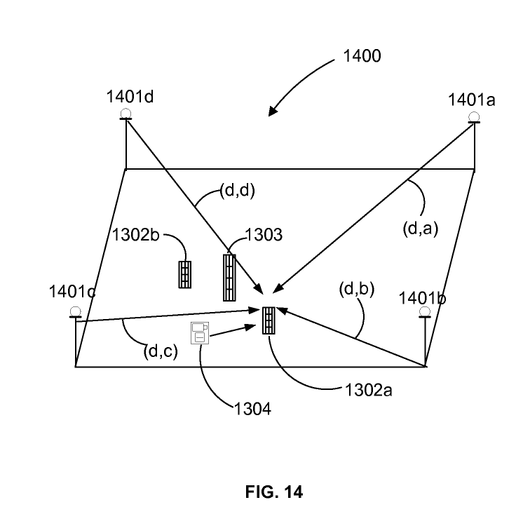

Referring back to FIG. 12, the audio-visual processing system 1204 accurately calculates the location of the sound from a target object by analyzing the latency and delays and phase shift of received sound waves from different sound sources. FIG. 14 shows a simplified overview of an exemplary immersive sound/audio processing 1400 by the audio-visual processing system 1204 according to one embodiment of the current invention. In the example illustrated in FIG. 14, two actors 1302a-b, a virtual camera 1304 and four microphones 1401a-d are positioned at different places of the recording scene. While actor 1302a is speaking, microphones 1401a-d can record the sound and each microphone 1401 has a distance measured from the target object (i.e., actor 1302a). For example, (d,a) represents the distance between the microphone 1401a and the actor 1302a. The audio-visual processing system 1204 receives sound information about the latency, delays and phase shift of the sound waves from the microphones 1401a-d. The audio-visual processing system 1204 analyzes the sound information to accurately determine the location of the sound source (i.e., actor 1302a or even which side of the actor's mouth). Based on the analysis, the audio-visual processing system 1204 generates a soundscape (also called sound texture map) of the recorded scene. Additionally, the audio-visual processing system 1204 may generate accurate sound source positions from objects outside the perimeter of a sound recording set.

A soundscape is a sound or combination of sounds that forms or arises from an immersive environment such as the audio-visual recording scene illustrated in FIGS. 12-14. Determining what is audible and when and where is audible has become a challenging part of characterizing a soundscape. The soundscape generated by the audio-visual processing system 1204 contains information to determine what, when and where is audible of a recorded scene. A soundscape can be modified during post-production (i.e., recording) period to create a variety of immersive sounds. For example, the soundscape created by the audio-visual processing system 1204 allows sonic texture mapping and reduces the need for manual mixing in post production. The audio-visual processing system 1204 supports rudimentary sound systems like 5.1 into 7.1 from a real camera and helps convert the sound system into a cylindrical audio texture map, allowing a virtual camera to pick up correct stereo sound. Actual outside recording is done channel-by-channel.

In one embodiment, each actor 1302 can be wired with his/her own microphone, so a recording director can control which voices are needed, but can't do with binaural sound. This approach may lead to some aural clutter. To aid in the creation of a complete video/audio/location simulation, each video frame can be stamped with location information of the audio source(s), absolute or relative to the camera 1304. Alternatively, the microphones 1401a-d on the cameras are combined with post processing to form virtual microphones with array of microphones by retargeting and/or remixing signal arrays.

In another embodiment, such an audio texture map can be used with software that can selectively manipulate, muffle or focus on location of a given array. For example, the soundscape can process both video and audio depth awareness and or alignment, and tag the recordings on each channel of audio and/or video that each actor has with information from the electronic beacon discussed above. In yet another embodiment, the electronic beacons may have local microphones worn by the actors to satisfy clear recording of voices without booms.

In cases where multiple people talking on two channels and the two channels are fused with background of individuals, it's traditionally hard to eliminate unwanted sound, but with the exact location from the soundscape, it is possible to use both sound signals from the two channels to eliminate the voice of one as background with respect to the other.

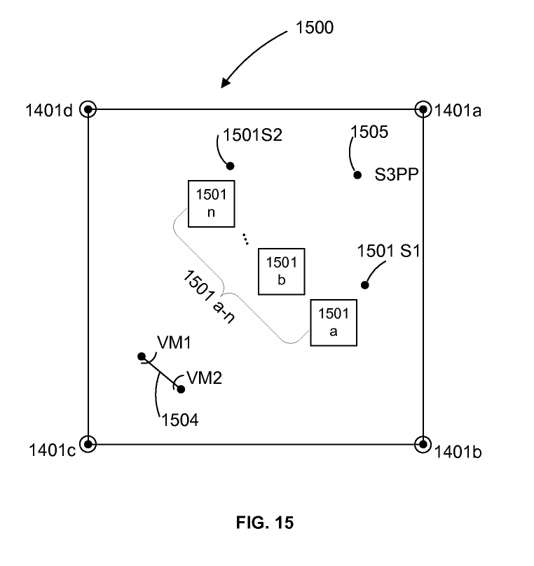

FIG. 15 shows an exemplary model of a soundscape 1500 according to one embodiment of the invention. The soundscape (or sound texture map) 1500 is generated by the audio-visual processing system 1204 as described above with reference to FIG. 14. In the sound texture map 1500, objects 1501a-n are imported from a visual texture map such as the visual texture map 1300 in FIG. 13. Sound sources 1501S1 and 1501S2 on the sound texture map 1500 identify the positions of sound sources that audio-visual processing system 11204 has calculated, such as, actors' mouths. The sound texture map 1500 also comprises a post-production sound source 1505 S3PP. For example, the post-production sound source 1505 S3PP can be a helicopter hovering overhead as a part of the video recording, either outside or inside the periphery of the recoding set. The audio-visual processing system 1204 may also insert other noises or sounds in post production period, giving these sound sources specific locations using the same or similar calculation as described above.

Also shown in FIG. 15 are four microphones 1401a-d and a virtual binaural recording system 1504, with two virtual microphones VM1 and VM2 that mimic a binaural recording microphone positioned in soundscape 1500 to match the position of the virtual camera 1304 in the video texture map 1300. Further, a virtual microphone boom can be achieved by post-production focusing of the sound output manually. For example, a virtual microphone boom is achieved by moving a pointer near a speaking actor's mouth, allowing those sounds to be elevated at post production and to sound much clearer. Thus, if a speaker is wearing a special audio and video presentation headgear, the virtual camera 1304 can show him/her the viewpoint from his/her virtual position, and the virtual binaural recording system 1504 can create the proper stereo sound for his/her ears, as if he/she were immersed in the correct location in the recoding scene. Other embodiments may employ multichannel stereo sound, such as 5-plus-1, 3-plus-1, or 7-plus-1 to create sound tracks for DVD type movies.

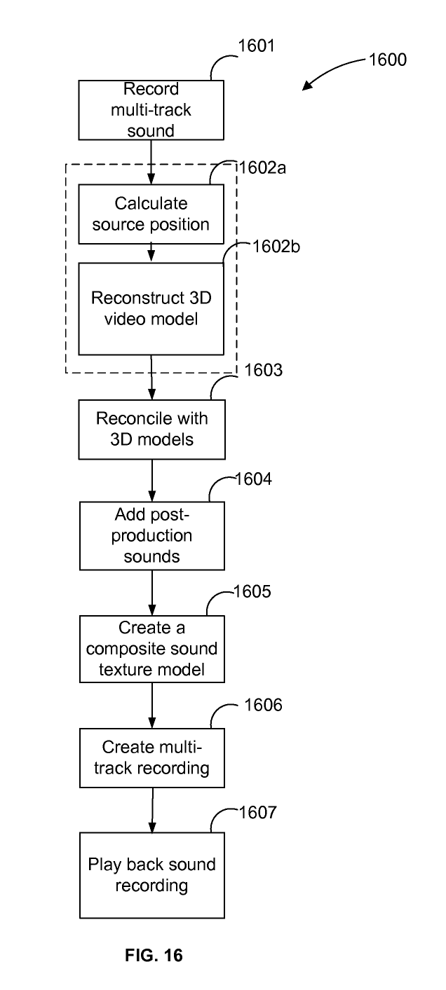

FIG. 16 shows an exemplary process 1600 for an audio and video production by the audio-visual processing system 1204 according to one embodiment of the invention. In step 1601 a multi-sound recording is created that has highest accuracy in capturing the video and audio without latency. In a preferred mode, cameras are beat synchronized where all video frames are taken concurrently. Other embodiments may not need cameras being set synchronized because video frame rate can be later interpolated if necessary. In steps 1602a, the processing system 1204 calculates the sound source position base on information of received sound waves such as phase, hull curve latency and/or amplitude of the hull curve. In steps 1602b, the processing system 1204 reconstructs video 3D model using any known video 3D reconstruction and texture mapping techniques. In step 1603, the processing system 1204 reconciles the 3-D visual and sound models to match the sound sources. In step 1604, the processing system 1204 adds post-production sounds such as trucks, overhead aircraft, crowd noise, an unseen freeway, etc., each with the correct directional information, outside or inside the periphery of a recording set. In step 1605, the processing system 1204 creates a composite textured sound model, and in step 1606, the processing system 1204 creates a multi-track sound recording that has multiple sound sources. In step 1607 the sound recording may be played back, using a virtual binaural or virtual multi-channel sound for the position of a virtual camera. This sound recording could be a prerecorded sound track for a DVD, or it could be a sound track for an immersive video-game type of presentation that allows a player to move his/her head position and both see the correct virtual scene through a virtual camera and hear the correct sounds of the virtual scene through the virtual binaural recording system 1504.

### Immersive Audio-Visual Editing

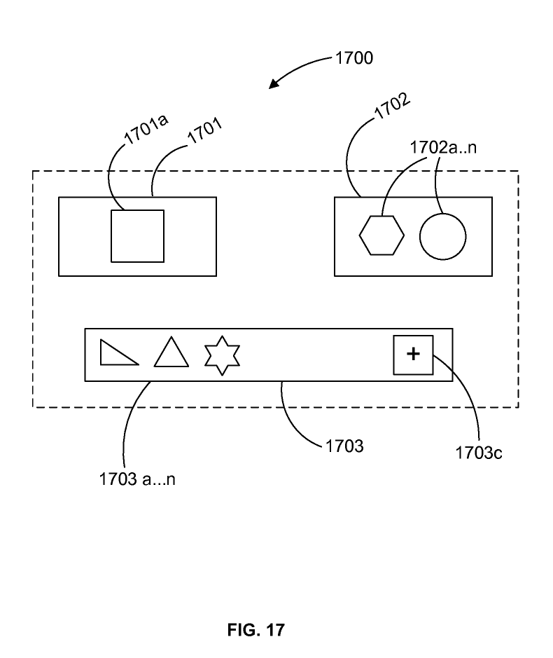

FIG. 17 is an exemplary screen of an immersive video editing tool 1700 according to one embodiment of the invention. The exemplary screen comprises a display window 1701 to display a full view video scene and a sub-window 1701a to display a subset view viewed through a participant's virtual reality helmet. Control window 1702 shows a video scene color coding of the sharp areas of the video scene and the sharp areas are identified using image processing techniques, such as edge detection based on available resolution of the video scene. Areas 1702a-n are samples of the sharp areas shown in the window 1702. In one embodiment, the areas 1702a-n are shown in various colors either relative to the video appearing in window 1701. The amount of color for an area 1702 can be changed to indicate the amount of resolution and or sharpness. In another embodiment, different color schemes, different intensities, or other distinguishing means may be used to indicate different sets of data. In yet another embodiment, the areas 1702a-n are shown as a semi-transparent area overlaying a copy of the video in window 1701 that is running in window 1702. The transparency of the areas 1702a-n can be modified gradually for the overlay, displaying information about one specific aspect or set of data of the areas 1702.

The exemplary screen of the video editing tool 1700 also shows a user interface window 1703 to control of elements of windows 1701 and 1702 and other items (such as virtual cameras and microphones not shown in the figure). The user interface window 1703 has multiple controls 1703a-n, of which only control 1703c is shown. Control 1703c is a palette/color/saturation/transparency selection tool that can be used to select colors for the areas 1702a-n. In one embodiment, sharp areas in the fovea (center of vision) of a video scene can be in full color, and low-resolution areas are in black and white. In another embodiment, the editing tool 1700 can digitally remove light of a given color from the video displayed in window 1701 or control window 1702, or both. In yet another embodiment, the editing tool 1700 synchronizes light every few seconds, and removes a specific video frame based on a color. In other embodiments, the controls 1703a-n may include a frame rate monitor for a recording director, showing effective frame rates available based on target resolution and selected video compression algorithm.

FIG. 18 is an exemplary screen of an immersive video scene playback for editing 1800 according to one embodiment of the invention. Window 1801 shows a full-view (i.e., “world view”) video with area 1801 a showing the section that is currently in the view of a participant in the video. Depending on the participant's headgear, the video can be an interactive or a 3D type of video. As the participant moves his/her head around, window 1801 a moves accordingly within “world view” 1801. Window 1802 shows the exact view as seen by the participant, typically same the view as in 1801. In one embodiment, elements 1802a-n are the objects of interest to the participant in an immersive video session. In another embodiment, elements 1802a-n can be the objects of no interest to the participant in an immersive video session

Window 1802 also shows the gaze 1803 of the participant, based on his/her pupil and/or retina tracking. Thus, the audio-visual processing system 1204 can determine how long the gaze of the participant rests on each object 1802. For example, if an object enters a participant's sight for a few seconds, the participant may be deemed to have “seen” that object. Any known retinal or pupil tracking device can be used with the immersive video playback 1800 for retinal or pupil tracking with or without some learning sessions for the integration concern. For example, such retinal tracking may be done by asking a participant to track, blink and press a button. Such retinal tracking can also be done using virtual reality goggles and a small integrated camera. Window 1804 shows the participant's arm and hand positions detected through cyberglove sensor and/or armament sensors. Window 1804 can also include gestures of the participant detected by motion sensors. Window 1805 shows the results of tracking a participant's facial expressions, such as grimacing, smiling, frowning, and etc.

The exemplary screen illustrated in FIG. 18 demonstrates a wide range of applications using the immersive video playback for editing 1800. For example, recognition of perceptive gestures of a participant with a cognitive queue, such as fast or slow hand gestures, or simple patterns of head movements, or checking behind a person, can be used in training exercises. Other uses of hand gesture recognition can include cultural recognition (e.g., detecting that in some cultures pointing is bad) and detecting selection of objects in virtual space (for example, move a finger to change the view field depth).

In one embodiment, the immersive video scene playback 1800 can retrieve basic patterns or advanced matched patterns from input devices such as head tracking, retinal tracking, or glove finger motion. Examples include the length of idle time, frequent or spastic movements, sudden movements accompanied by freezes, etc. Combining various devices to record patterns can be very effective at incorporating larger gestures and cognitive implications for culture-specific training as well as for general user interface. Such technology would be a very intuitive approach for any user interface browse/select process, and it can have implications for all computing if developed cost-effectively. Pattern recognition can also include combinations, such as recognizing an expression of disapproval when a participant points and says “tut, tut tut,” or combinations of finger and head motions of a participant as gestural language. Pattern recognition can also be used to detect sensitivity state of a participant based on actions performed by the participant. For example, certain actions performed by a participant indicate wariness. Thus, the author of the training scenario can anticipate lulls or rises in a participant's attention span and to respond accordingly, for example, by admonishing a participant to “Pay attention” or “Calm down”, etc.).

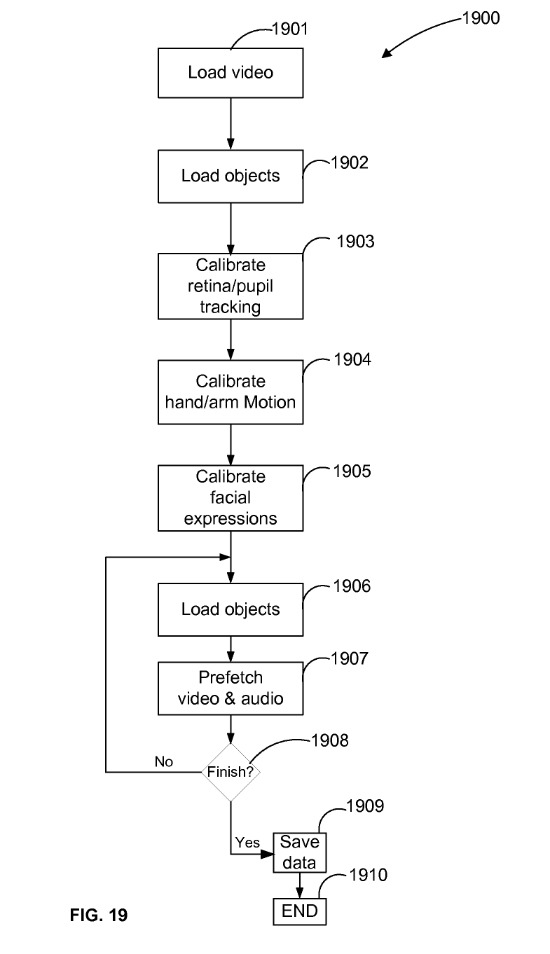

FIG. 19 is a flowchart illustrating a functional view of applying the immersive audio-visual production to an interactive training session according to one embodiment of the invention. Initially, in step 1901, an operator loads a pre-recorded immersive audio-visual scenes (i.e., dataset), and in step 1902 the objects of interest are loaded. In step 1903 the audio-visual production system calibrates retina and/or pupil tracking means by giving the participant instructions to look at specific objects and adjusting the tracking devices according to the unique gaze characteristics of the participant. In step 1904, similarly, the system calibrates tracking means for tracking hand and arm positions and gestures by instructing the participant to execute certain gestures in a certain sequence, and recording and analyzing the results and adjusting the tracking devices accordingly. In step 1905 the system calibrates tracking means for tracking a participant's facial expressions. For example, a participant may be instructed to execute a sequence of various expressions, and the tracking means is calibrated to recognize each expression correctly. In step 1906, objects needed for the immediate scene and/or its additional data are loaded in to the system. In step 1907 the video and audio prefetch starts. Enhanced video quality is based on the analysis of head motions and other accelerators, by preloading higher resolution into the anticipated view field in one embodiment. In another embodiment, enhanced video quality is achieved by decompressing the pre-recorded immersive audio-visual scenes fully or partially. In step 1908 the system checks to see if the session is finished. If not (“No”), the process loops back to step 1906. If the system determines that the session is finished (“Yes”) upon a request (for example, voice recognition of a keyword, bush of a button, etc.) from the trainer or trainee (participant), or by exceeding the maximum time allotted for the video, the system saves training session data in step 1909 before the process terminates in step 1910. In some embodiments, only parts of the pre-recorded immersive audio-visual scenes are used in the processing described above.

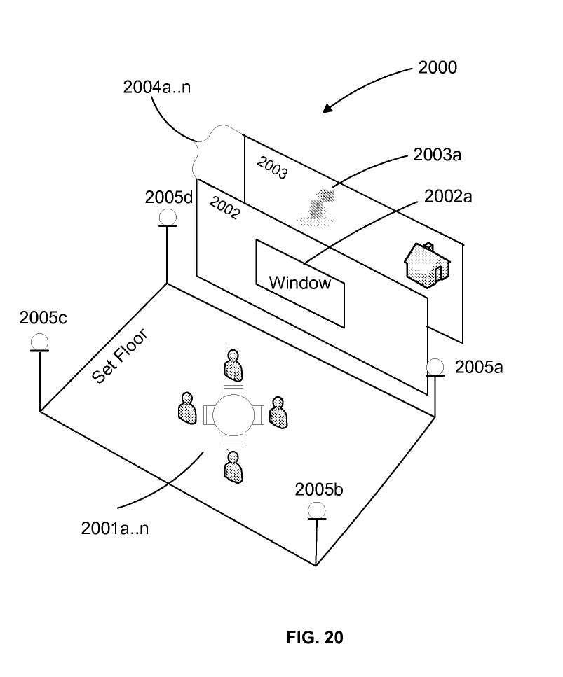

FIG. 20 is an exemplary view of an immersive video recording set 2000 according to one embodiment of the invention. In the exemplary recoding set 2000 illustrated in FIG. 20, the recording set 2000 comprises a set floor and in the floor center area there are a plurality of participants and objects 2001a-n (such as a table and chairs). The set floor represents a recording field of view. At the edge of the recording field of view, there are virtual surfaces 2004a-n. The recording set 2000 also includes a matte of a house wall 2002 with a window 2002a, and an outdoor background 2003 with an object 2003a that is partially visible through window 2002a. The recording set 2000 also includes a multiple audio/video recording devices 2005a-d (such as microphones and cameras). The exemplary recording set illustrated in FIG. 20 can be used to simulate any of several building environments and, similarly, outdoor environments. For example, a building on the recording set 2000 can be variously set in a grassy field, in a desert, in a town, or near a market, etc. Furthermore, post-production companies can bid on providing backgrounds as a set portraying a real area based on video images of said areas captured from satellite, aircraft, or local filming, and etc.

### Immersive Video Cameras

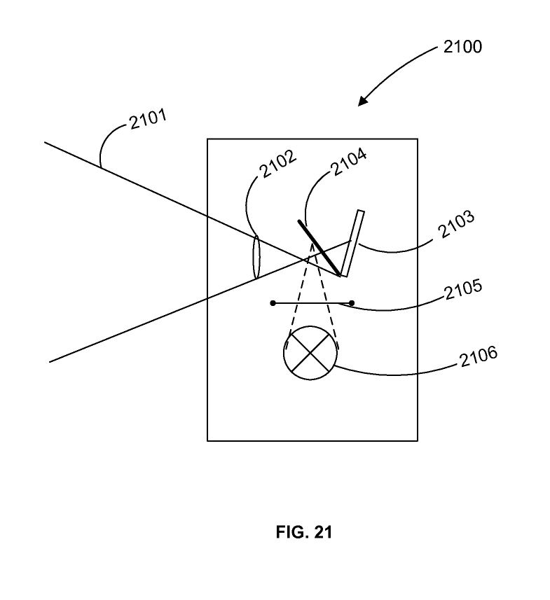

FIG. 21 is an exemplary immersive video scene view field through a camera 2100 according to one embodiment of the invention. The novel configuration of the camera 2100 enables production of a stereoscopically correct view field for the camera. An important aspect to achieve a correct sense of scale and depth in any stereoscopic content is to match the viewing geometry with the camera geometry. For content that is world scale and observed by a human, this means matching the fields of view of the recording cameras to the fields of view (one for each eye, preferably with correct or similar distance) of the observer to the eventual stereoscopic projection environment.

One embodiment of the camera 2100 illustrated in FIG. 21 comprises a standard view field 2101 that goes through lens 2102 (only one lens shown for simplicity). The camera 2100 also allows light to be sent to an image sensor 2103. A semi mirror 2104 is included that allows a projection 2105 of a light source 2106 which is a light bulb in the illustrated embodiment. In one embodiment, light that is used may be invisible to the normal human eyes but may be seen through a special goggle, such as infrared or ultraviolet light. In another embodiment, laser or any of various other light sources currently available may be used as light source 2106 instead of a light bulb. For example, a recording director can wear special glasses (for invisible light) and/or a pair of stagehands to ensure that no objects can be in the view field. Thus, the illustrated stereoscopic projection environment can produce a stereoscopically correct view field for the camera.

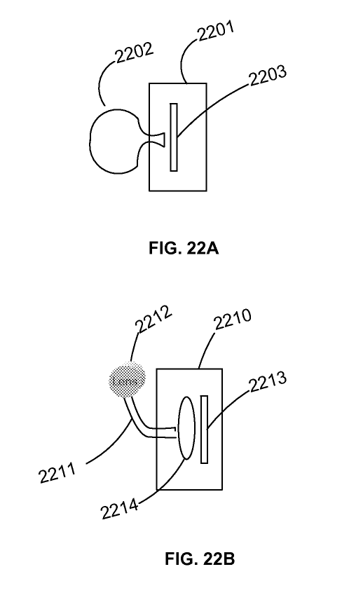

Various types of video cameras can be used for video capturing/recording. FIG. 22A is an exemplary super fisheye camera 2201 for immersive video recoding according to one embodiment of the invention. A fisheye camera has a wide-angle lens that take in an extremely wide, hemispherical image. Hemispherical photography has been used for various scientific purposes and has been increasingly used in immersive audio-visual production. The super fisheye camera 2201 comprises a bulb-shape fish lens 2202 and an image sensor 2203. The fisheye lens 2202 is directly coupled to the image sensor 2203.

FIG. 22B is an exemplary camera lens configuration for immersive video recording according to one embodiment of the invention. The camera 2210 in FIG. 22B comprises a lens 2212, a fiber optic cable 2211, a lens system 2214 and an image sensor 2213. Comparing with the camera lens configuration illustrated in FIG. 22A where the camera 2201 is required to be located on the periphery of the recoding set, the lens 2212 is mounted on the fiber optic cable 2211, thus allowing the camera 2210 to be mounted somewhere hidden, for example, within an object on the set out of the participant's field of view.

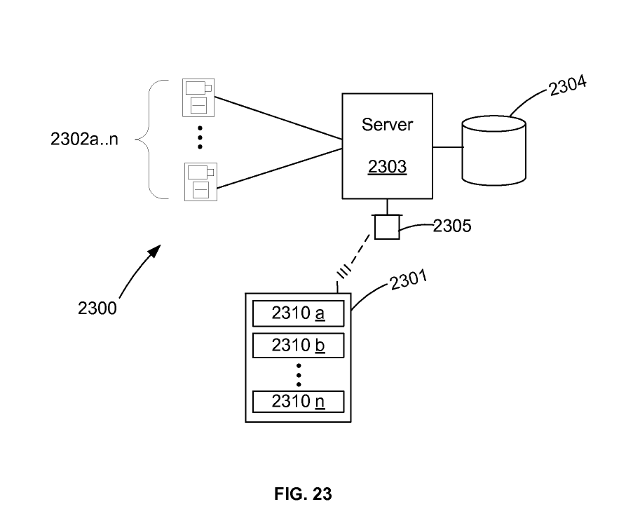

FIG. 23 is an exemplary immersive video viewing system 2300 using multiple cameras according to one embodiment of the invention. The viewing system 2300 comprises a hand-held device 2301, multiple cameras 2302a-n, a computer server 2303, a data storage device 2304 and a transmitter 2305. The server 2305 is configured to implement the immersive audio-visual production of the invention. The cameras 2302 are communicatively connected to the server 2305. The immersive audio-visual data produced by the server 2303 is stored in the data storage device 2304. The server 2303 is also communicatively coupled with the transmitter 2305 to send out the audio-visual data wirelessly to the hand held device 2301 via the transmitter 2305. In another embodiment, the server 2303 sends the audio-visual data to the hand held device 2301 through land wire via the transmitter 2305. In another embodiment, the server 2303 may use accelerometer data to pre-cache and pre-process data prior to viewing requests from the hand held device 2301.

The handheld device 2301 can have multiple views 2310a-n of the received audio-visual data. In one embodiment, the multiple views 2310a-n can be the views from multiple cameras. In another embodiment, the view 2301 can be a stitched-together view from multiple view sources. Each of the multiple views 2310a-n can have a different resolution, lighting as well as compression-based limitations on motion. The multiple views 2310a-n can be displayed in separate windows. Having multiple views 2310a-n of one audio-visual recording gives recording director and/or stagehands an alert about potential problems in real time during the recording and enables real-time correction of the problems. For example, responsive to frames changing rate, the recording director can know if the frames go past a certain threshold, or can know if there is a problem in a blur factor. Real-time problem solving enabled by the invention reduces production cost by avoiding re-recording the scene again later at much higher cost.

It is clear that many modifications and variations of the embodiment illustrated in FIG. 23 may be made by one skilled in the art without departing from the spirit of this disclosure. In some cases, the system 2300 can include the ability to display a visible light that is digitally removed later. For example, it can shine light in given color so that wherever that color lands, individuals know they are on set and should get out of the way. This approach allows the light to stay on, and multiple takes can be filmed without turning the camera on and off repeatedly, thus speeding filming.

Additionally, the viewing system 2300 provides a 3-step live previewing to the remote device 2301. In one embodiment, the remote device 2301 needs to have large enough computing resources for live previewing, such as a GPS, an accelerometer with 30 Hz update rate, wireless data transfer at a minimum of 802.11g, display screen at or above 480×320 with a refresh rate of 15 Hz, 3d texture mapping with a pixel fill rate of 30 Mpixel, RGBA texture maps at 1024×1024 resolutions, and a minimum 12 bit rasterizer to minimize distortion of re-seaming. Step one of the live previewing is camera identifications, using the device's GPS and accelerometer to identify lat/long/azimuth location and roll/pitch/yaw orientation of each camera by framing the device inside the camera's view to fit fixed borders given the chosen focus settings. The device 2301 records the camera information along with an identification (ID) from the PC which down samples and broadcasts the camera's image capture. Step two is to have one or more PCs broadcasting media control messages (start/stop) to the preview device 2301 and submitting the initial wavelet coefficients for each camera's base image. Subsequent updates are interleaved by the preview device 2301 to each PC/camera-ID bundle for additional updates to coefficients based on changes. This approach allows the preview device 2301 to pan and zoom across all possible cameras and minimize the amount of bandwidth used. Step three is for the preview device to decode the wavelet data into dual-paraboloid projected textures and texture map of a 3-D mesh-web based on the recorded camera positions. Stitching between camera views can be mixed using conical field of view (FOV) projections based on the recorded camera positions and straightforward Metaball compositions. This method can be fast and distortion-free on the preview device 2301.

Alternatively, an accelerometer can be a user interface approach for panning. Using wavelet coefficients allows users to store a small amount of data and only update changes as needed. Such an accelerometer may need a depth feature, such as, for example, a scroll wheel, or tilting the top of the accelerometer forward to indicate moving forward. Additionally, if there are large-scale changes that the bandwidth cannot handle, the previewer would display smoothly blurred areas until enough coefficients have been updated, avoiding the blocky discrete cosine transform (DCT) based artifacts often seen as JPEGs or HiDef MPEG-4 video is resolved.

In one embodiment, the server 2303 of the viewing system 2300 is configured to apply luminosity recording and rendering of objects to compositing CGI-lit objects (specular and environmental lighting in 3-D space) with the recorded live video for matching lighting in a full 360 range. Applying luminosity recording and rendering of objects to CGI-lit objects may require a per camera shot of a fixed image sample containing a palette of 8 colors, each with a shiny and matte band to extract luminosity data like a light probe for subsequent calculation of light hue, saturation, brightness, and later exposure control. The application can be used for compositing CGI-lit objects such as explosions, weather changes, energy (HF/UFH visualization) waves, or text/icon symbols. The application can be also be used in reverse to alter the actual live video with lighting from the CGI (such as in an explosion or energy visualization). The application increases immersion and reduces disconnection a participant may have between the two rendering approaches. The recorded data can be stored as a series of 64 spherical harmonics per camera for environment lighting in a simple envelope model or a computationally richer PRT (precomputed radiance transfer) format if the camera array is not arranged in an enveloping ring (such as embedding interior cameras to capture concavity). The application allows reconstruction and maintenance of soft-shadows and low-resolution, colored diffuse radiosity without shiny specular highlights.

In another embodiment, the server 2303 is further configured to implement a method for automated shape tracking/selection that allow users to manage shape detection over multiple frames to extract silhouettes in a vector format, and allows the users to chose target-shapes for later user-selection and basic queries in the scripting language (such as “is looking at x” or “is pointing away from y”) without having to explicitly define the shape or frame. The method can automate shape extractions over time and provide a user with a list to name and use in creating simulation scenarios. The method avoids adding rectangles manually and allows for later overlay rendering with a soft glow, colored highlight, higher-exposure, etc. if the user has selected something. Additionally, the method extends a player options from multiple choice to pick one or more of the following people or things.

In another embodiment, the viewing system is configured to use an enhanced compression scheme to move processing from a CPU to a graphics processor unit in a 3D graphics system. The enhanced compression scheme uses a wavelet scheme with trilinear filtering to allow major savings in terms of computing time, electric power consumption and cost. For example, the enhanced compression scheme may use parallax decoding utilizing multiple graphics processor units to simulate correct stereo depth shifts on rendered videos (‘smeared edges’) as well as special effects such as depth-of-field focusing while optimizing bandwidth and computational reconstruction speeds.

Other embodiments of the viewing system 2300 may comprise other elements for an enhanced performance. For example, the viewing system 2300 may includes heads-up displays that have bad pixels near peripheral vision, and good pixels near the fovea (center of vision). The viewing system 2300 may also include two video streams to avoid/create vertigo affects, by employing alternate frame rendering. Additional elements of the viewing system 2300 include a shape selection module that allows a participant to select from an author-selected group of shapes that have been automated and/or tagged with text/audio cues, and a camera cooler that minimizes condensation for cameras.

For another example, the viewing system 2300 may also comprises digital motion capture module on a camera to measure the motion when a camera is jerky and to compensate for the motion with images to reduce vertigo. The viewing system 2300 may also employ a mix of cameras on set/ off set and stitches together the video uses a wire-frame and builds a texture map of a background by means of a depth finder combined with spectral lighting analysis and digital removal of sound based on depth data. Additionally, an accelerometer in a mobile phone can be used for viewing a 3D or virtual window. A holographic storage can be used to unwrap video using optical techniques and to recapture the video by imparting a corrective optic into the holographic system, parsing out images differently than writing them to the storage.

### Immersion Devices

Many existing virtual reality systems have immersion devices for immersive virtual reality experiences. However, these existing virtual reality systems have major drawbacks in terms of limited field of view, lack of user friendliness and disconnect between the real world being captured and the immersive virtual reality. What is needed is an immersion device that allows a participant to feel and behave with “being there” type of truly immersion.

FIG. 24 shows an exemplary immersion device of the invention according to one embodiment of the invention. A participant's head 2411 is covered by a visor 2401. The visor 2401 has two symmetric halves with elements 2402a through 209a on one half and elements 2402b through 2409b on the other half. Only one side of the visor 2401 is described herein, but this description also applies in all respects to the other symmetric half. The visor 2401 has a screen that can have multiple sections. In the illustrated embodiment, only two sections 2402a and 2403a of the screen are shown. Additional sections may also be used. Each section has its own projector. For example, the section 2402a has a projector 2404a and the section 2403a has a projector 2405a. The visor 2401 has a forward-looking camera 2406 to adjust viewed image for distortion and to overlap between the sections 2402a and 2403a for providing stereoscopic view to the participant. Camera 2406a is mounted inside the visor 2401 and can see the total viewing area which is the same view as the one of the participant.

The visor 2401 also comprises an inward-looking camera 2409a for adjusting eye base distance of the participant for an enhanced stereoscopic effect. For example, during the set-up period of the audio-visual production system, a target image or images, such as, an X, or multiple stripes, or one or more other similar images for alignment, is generated on each of the screens. The target images are moved by either adjusting the inward-looking camera 2409a mechanically or adjusting the pixel position in the view field until the targets are aligned. The inward-looking camera 2409a looks at the eye of the participant in one embodiment for retina tracking, pupil tracking and for transmitting the images of the eye for visual reconstruction.

In one embodiment, the visor 2401 also comprises a controller 2407a that connects to various recording and computing devices and an interface cable 2408a that connects the controller 2407a to a computer system (not shown). By moving some of the audio-visual processing to the visor 2401 and its attached controllers 2407 rather than to the downstream processing systems, the amount of bandwidth required to transmit audio-visual signals can be reduced.

On the other side of the visor 2401, all elements 2402a-2409a are mirrored with same functionality. In one embodiment, two controllers 2407a and 2407b (controller 2407b not shown) may be connected together in the visor 2401 by the interface cable 2408a. In another embodiment, each controller 2407 may have its own cable 2408. In yet another embodiment, one controller 2407a may control all devices on both sides of the visor 2401. In other embodiments, the controller 2407 may be apart from the head-mounted screens. For example, the controller 2407 may be worn on a belt, in a vest, or in some other convenient locations of the participant. The controller 2407 may also be either a single unitary device, or it may have two or more components.

The visor 2401 can be made of reflective material or transflective material that can be changed with electric controls between transparent and reflective (opaque). The visor 2401 in one embodiment can be constructed to flip up and down, giving the participant an easy means to switch between the visor display and the actual surroundings. Different layers of immersion may be offered by changing the openness or translucency of screen layers of immersion. Changing the openness or translucency of the screens can be achieved by changing the opacity of the screens or by adjusting the level of reality augmentation. In one embodiment, each element 2402-2409 described above may connect directly by wire to a computer system. In case of a high-speed interface, such as USB, or in a wireless interface, such as a wireless network, each element 2402-2409 can send one signal that can be broken up into discrete signals in controller 2407. In another embodiment, the visor 2401 has embedded computing power, and moving the visor 2401 may help run applications and or software program selection for immersive audio-visual production. In all cases, the visor 2401 should be made of durable, non-shatter material for safety purposes.

The visor 2401 described above may also attach to an optional helmet 2410 (in dotted line in FIG. 20). In another embodiment, the visor 2401 may be fastened to a participant's head by means of a headband or similar fastening means. In yet another embodiment, the visor 2401 can be worn in a manner similar to eyeglasses. In one embodiment, a 360-degree view may be used to avoid distortion. In yet another embodiment, ajoystick, a touchpad or a cyberglove may be used to set the view field. In other embodiments, an accelerated reality may be created, using multiple cameras that can be mounted on the helmet 2410. For example, as the participant turns his/her head 5 degrees to the left, the view field may turn 15 or 25 degrees, allowing the participant, by turning his/her head slightly to the left or the right to effectively see behind his/her head. In addition, the head-mounted display cameras may be used to generate, swipe and compose giga-pixel views. In another embodiment, the composite giga-pixel views can be created by having a multitude of participants in the recording field wearing helmets and/or visors with external forward-looking cameras. The eventual 3D virtual reality image may be stitched from the multiple giga-pixel views in manners similar to the approaches described above with reference to FIGS. 2-6. If an accelerometer is present, movement of the participant's head, such as nodding, blinking, tilting the head, etc., individually or in various combinations, may be used for interaction commands.

In anther embodiment, augmented reality using the visor 2401 may be used for members of a “friendly” team during a simulated training session. For example, a team member from a friendly team may be shown in green, even though he/she may actually not be visible to the participant wearing the visor 2401 behind a first house. A member of an “enemy” team who is behind an adjacent house and who has been detected by a friendly team member behind the first house may be shown in red. The marked enemy is also invisible to the participant wearing the visor 2401. In one embodiment, the visor 2401 display may be turned blank and transparent when the participant may be in danger of running into an obstacle while he/she is moving around wearing the visor.

FIG. 25 is another exemplary immersion device 2500 for the immersive audio-visual system according to one embodiment of the invention. The exemplary immersion device is a cyberglove 2504 in conjunction with a helmet 2410 as described in FIG. 24. The cyberglove 2504 comprises a control 2501, a motion sensor 2503 and multiple sensor strips 2502a-e in the fingers of the cyberglove 2504. The controller 2501 calculates the signals made by bending the finger through the sensors 202a-e. In another embodiment, a pattern can be printed on the back side of the cyberglove 2504 (not shown in FIG. 25) to be used in conjunction with an external forward-looking camera 2510 and in conjunction with an accelerometer 2511 on helmet 2410 to detect relative motion between the cyberglove 2504 and the helmet 2410.

The cyberglove 2504 illustrated in FIG. 25 may be used for signaling commands, controls, etc., during a simulation session such as online video gaming and military training session. In one embodiment, the cyberglove 2504 may be used behind a participant's back or in a pocket to send signs, similar to sign language or to signals commonly used by sports teams (e.g., baseball, American football, etc.), without requiring a direct visual sighting of the cyberglove 2504. The cyberglove 2504 may appear in another participant's visor floating in the air. The cyberglove 2504 displayed on the visor may be color coded, tagged with a name or marked by other identification means to identify who is the signaling through the cyberglove 2504. In another embodiment, the cyberglove 2504 may have haptic feedback by tapping another person's cyberglove 2504 or other immersion device (e.g., a vest). In yet another embodiment, the haptic feedback is inaudible by using low frequency electromagnetic inductors.

### Interactive Casino-Type Gaming System

The interactive audio-visual production described above has a variety of applications. One of the applications is interactive casino-type gaming system. Even the latest and most appealing video slot machines fail to fully satisfy players and casino needs. Such needs include the need to support culturally tuned entertainment, to lock a player's experience to a specific casino, to truly individualize entertainment, to fully leverage resources unique to a casino, to tie in revenue from casino shops and services, to connect players socially, to immerse players, and to enthrall the short attention spans of players of the digital generation. What is needed is a method and system to integrate gaming machines with service and other personnel supporting and roaming in and near the area where the machines are set up.

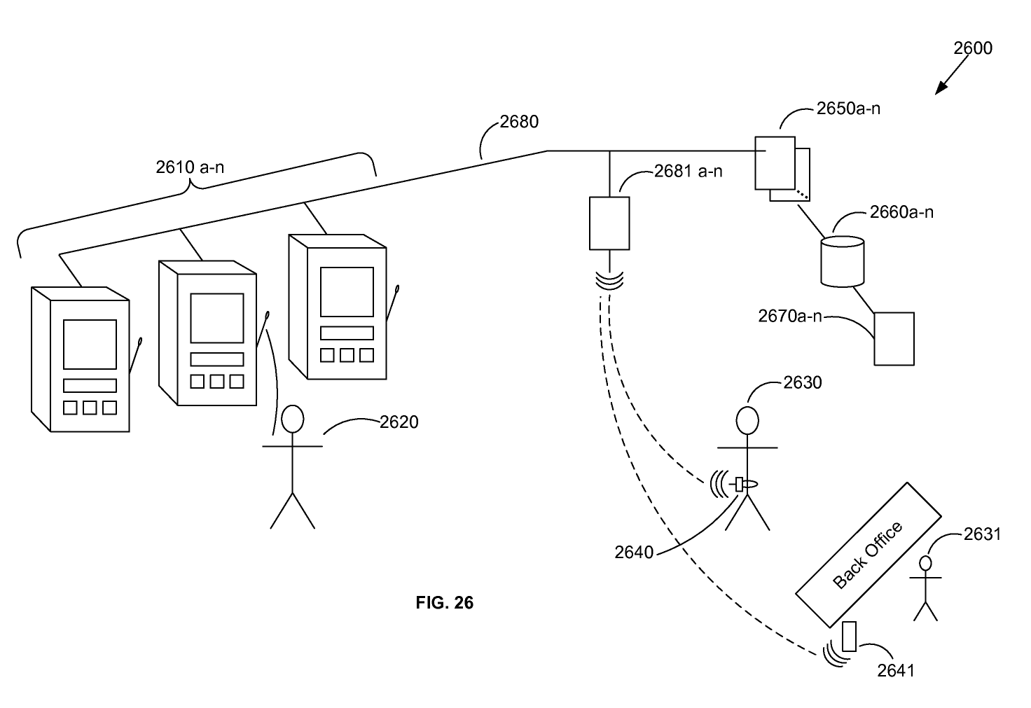

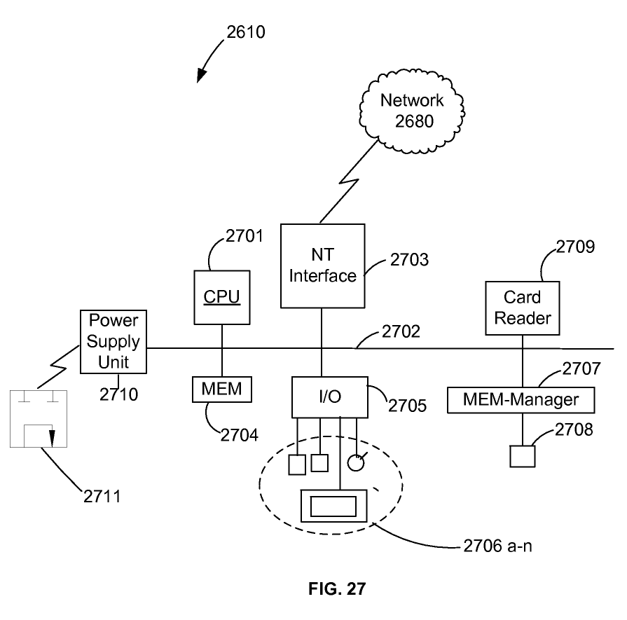

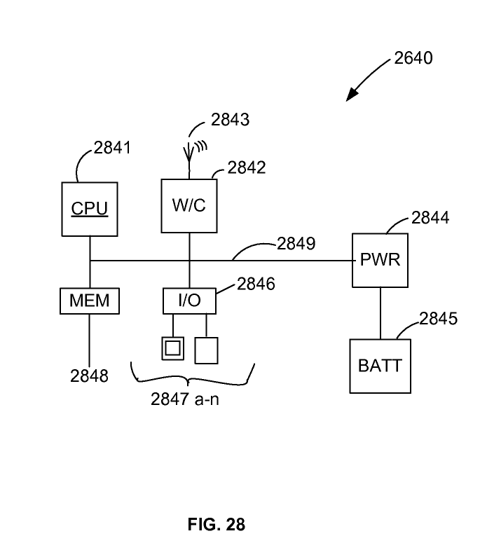

FIG. 26 is a block diagram illustrating an interactive casino-type gaming system 2600 according to one embodiment of the invention. The system 2600 comprises multiple video-game-type slot machines 2610a-n. The slot machines 2610a-n may have various physical features, such as buttons, handles, a large touch screen or other suitable communication or interaction devices, including, but not limited to, laser screens, infrared scanners for motion and interaction, video cameras for scanning facial expressions. The slot machines 2610a-n are connected via a network 2680 to a system of servers 2650a-n. The system 2600 also comprises multiple wireless access points 2681a-n. The wireless access points 268la-n can use standard technologies such as 802.11b or proprietary technologies for enhanced security and other considerations. The system 2600 also comprises a number of data repositories 2860a-n, containing a number of data sets and applications 2670a-n. A player 2620a is pulling down a handle on one of the machines 2610a-n. A service person 2630a wears on a belt a wireless interactive device 2640a that may be used to communicate instructions to other service personnel or a back office. In one embodiment, the interactive device 2640a is a standard PDA device communicating on a secure network such as the network 2680. A back office service person 2631, for example, a bar tender, has a terminal device 2641, which may be connected to the network 2680 with wire or wirelessly. The terminal device 2641 may issue instructions for a variety of services, such as beverage services, food services, etc. The slot machine 2610 is further described below with reference to FIG. 27. The wireless interactive device 2640 is further described below with reference to FIG. 28.

FIG. 27 is an exemplary slot machine 2610 of the casino-type gaming system 2600 according to one embodiment of the invention. The slot machine 2710 comprises an AC power connection 2711 supplying power to a power supply unit 2610. The slot machine 2610 also comprises a CPU 2701 for processing information, a computer bus 2702 and a computer memory 2704. The computer memory 2704 may include conventional RAM, nonvolatile memory, and/or a hard disk. The slot machine 2610 also has an I/O section 2705 that may have various different devices 2706a-n connected to it, such as buttons, camera(s), additional screens, main screen, touch screen, lever as is typical in slot machines. In another embodiment, the slot machine 2610 can have a sound system and other multimedia communications devices. In one embodiment, the slot machine 2610 may have a radio-frequency identification (RFID) and/or a card reader 2709 with an antenna. The card reader 2709 can read RFID tags of credit cards or tags that can be handed out to players, such as bracelets, amulets and other devices. These tags allow the slot machine 2610 to recognize users as very-important-persons (VIPs) or any other classes of users. The slot machine 2610 also comprises a money manager device 2707 and a money slot 2708 available for both coins and paper currency. The money manager device 2707 may indicate the status of the slot machine 2610, such as whether the slot machine 2610 is full of money and needs to be emptied, or other conditions that need service. The status information can be communicated back to the system 2600 via the network 2680 connected to the network interface 2703.

FIG. 28 is an exemplary wireless interactive device 2640 of the casino-type gaming system 2600 according to one embodiment of the invention. The interactive device 2640 has an antenna 2843 connecting the interactive device 2640 via a wireless interface 2842 to a computer bus 2849. The interactive device 2640 also comprises a CPU 2841, a computer memory 2848, an I/O system 2846 with I/O devices such as buttons, touch screens, video screens, speakers, etc. The interactive device 2640 also comprises a power supply and control unit 2844 with a battery 2845 and all the circuitry needed to recharge the interactive device 2640 in any of various locations, either wirelessly or with wired plug-ins and cradles.

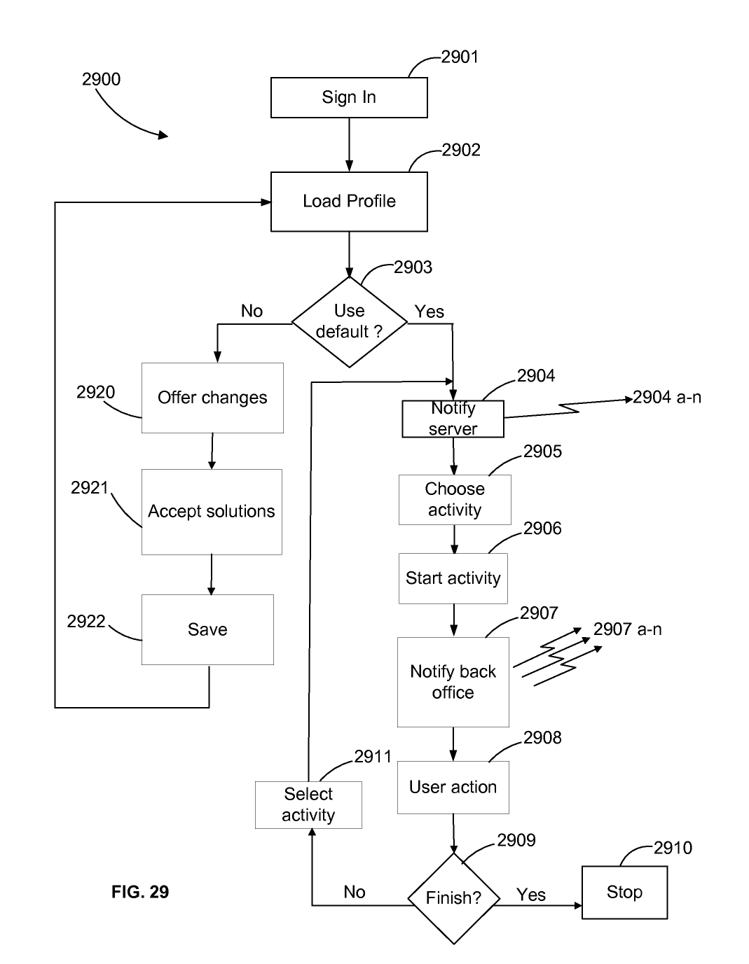

FIG. 29 is a flowchart illustrating a functional view of interactive casino-type gaming system 2600 according to one embodiment of the invention. In step 2901, a customer signs in a slot machine by any of various means, including swiping a coded club member card, or standing in front of the machine until an RFID unit in the machine recognizes some token in his /her possession. In another embodiment, the customer may use features of an interaction devices attached on the slot machine for signing in. For example, the customer can type a name and ID number or password. In step 2902 the customer's profile is loaded from a data repository via the network connection described above. In step 2903, the customer is offered the option of changing his/her default preferences, or setting up default preferences if he/she has no recorded preferences. If the customer elects to use his/her defaults (“Yes”), the process moves to step 2904. The system notifies a service person of the customer's selections by sending one or more signals 2904a-n, which are sent out as a message from a server via wireless connection to the service person. The notified service person brings a beverage or other requested items to this player. In one embodiment, a specific service person may be assigned to a player. In another embodiment, each customer may choose a character to serve him, and the service persons are outfitted as the various characters from which the customers may choose. Examples of such characters may include a pirate, an MC, or any character that may be appropriate to, for example, a particular theme or occasion. So rather than requesting a specific person, the user can request a specific character. Along with a notification of a customer request to the service person, the system may send information about the status of this player, such as being an ordinary customer, a VIP customer, a customer with special needs, a super high-end customer, etc. In step 2905, the customer may choose his/her activity, and in step 2906, the chosen activity lunches by the system. The system may retrieve additional data from the data repository for the selected activity.

In step 2907, at certain points during the activity, the customer may desire, or the activity may require, additional orders. The system notifies the back office for the requested orders. For example, in some sections in a game or other activity, a team of multiple service persons may come to the user to, for example, sing a song or cheer on the player or give hints or play some role in the game or other activity. In other cases, both service persons and videos on nearby machines may be a part of the activity. Other interventions at appropriate or user-selected times in the activity may include orders of food items, non-monetary prizes, etc. These attendances by service persons and activity-related additional services may be repeated as many times as are appropriate to the activity and/or requested by the user. In step 2908, the customer may choose another activity or end current activity. Responsive to customer ending an activity, the process terminates in step 2910. If the customer decides to continue to use the system, the process moves to step 2911, where the customer may select another activity, such as adding credits to his/her account, and making any other decisions before returning to the process at step 2904.

Responsive to the customer requesting changes to his/her profile at step 2903 (“No”), the system offers the customer changes in step 2920, accepts his/her selections in step 2921, and, stores the changes in the data repository in step 2922. The process returns to step 2902 with updated profile and allows the customer to reconsider his/her changes before proceeding to the activities following the profile update. In one embodiment, the user profile may contain priority or status information of a customer. The higher the priority or status a customer has, the more attention he/she may receive from the system and the more prompt his/her service is. In another embodiment, the system may track a customer's location and instruct the nearest service person to serve a specific user or a specific machine the customer is associated with. The interactive devices 2640 that service persons carry may have various types and levels of alert mechanisms, such as vibrations or discrete sounds to alert the service person to a particular type of service required. By merging the surroundings in the area of activities and the activity itself, a more immersive activity experience is created for customers in a casino-type gaming environment.

### Simulated Training System

Another application of interactive immersive audio-visual production is interactive training system to raise awareness of cultural differences. Such awareness of cultural differences is particularly important for military personnel stationed in countries of a different culture. Without proper training, misunderstandings can quickly escalate, leading to alienation of local population and to public disturbances including property damage, injuries and even loss of life. What is needed is a method and system for fast, effective training of personnel in a foreign country to make them aware of local cultural differences.

FIG. 30 is an interactive training system 3000 using immersive audio-visual production according to one embodiment of the invention. The training system 3000 comprises a recording engine 3010, an analysis engine 3030 and a post-production engine 3040. The recording engine 3010, the analysis engine 3030 and the post-production engine 3040 are connected through a network 3020. The recording engine 3010 records immersive audio-visual scenes for creating interactive training programs. The analysis engine 3030 analyzes the performance of one or more participants and their associated immersive devices during the immersive audio-visual scene recoding or training session. The post-production engine 3040 provides post-production editing. The recording engine 3010, the analysis engine 3030 and the post-production engine 3040 may be implemented by a general purpose computer or similar to the video rendering engine 204 illustrated in FIG. 5.

In one embodiment of the invention, the network 3020 is a partially public or a globally public network such as the Internet. The network 3020 can also be a private network or include one or more distinct or logical private networks (e.g., virtual private networks or wide area networks). Additionally, the communication links to and from the network 3020 can be wire line or wireless (i.e., terrestrial- or satellite-based transceivers). In one embodiment of the invention, the network 3020 is an IP-based wide or metropolitan area network.

The recording engine 3010 comprises a background creation module 3012, a video scene creation module 3014 and an immersive audio-visual production module 3016. The background creation module 3012 creates scene background for immersive audio-visual production. In one embodiment, the background creation module 3012 implements the same functionalities and features as the scene background creation module 201 described with reference to FIG. 3A.

The video scene creation module 3014 creates video scenes for immersive audio-visual production. In one embodiment, the background creation module 3012 implements the same functionalities and features as the video scene creation module 202 described with reference to FIG. 3B.

The immersive audio-visual production module 3016 receives the created background scenes and video scenes from the background creation module 3012 and video scene creation module 3014, respectively, and produces an immersive audio-visual video. In one embodiment, the production module 3016 is configured as the immersive audio-visual processing system 1204 described with reference to FIG. 12. The production engine 3016 employs a plurality of immersive audio-visual production tools/systems, such as the video rendering engine 204 illustrated in FIG. 5, the video scene view selection module 415 illustrated in FIG. 4, the video playback engine 800 illustrated in FIG. 8, and the soundscape processing module illustrated in FIG. 15, etc.

The production engine 3016 uses a plurality of microphones and cameras configured to optimize immersive audio-visual production. For example, in one embodiment, the plurality cameras used in the production are configured to record 2×8 views, and the cameras are arranged as the dioctographer illustrated in FIG. 10. Each of the cameras used in the production can record an immersive video scene view field illustrated in FIG. 21. The camera used in the production can be a super fisheye camera illustrated in FIG. 22A.

A plurality of actors and participants may be employed in the immersive audio-visual production. A participant may wear a visor similar or same as the visor 2401 described with reference to FIG. 24. The participant may also have one or more immersion tools as such the cyberglove 2504 illustrated in FIG. 25.

The analysis engine 3030 comprises a motion tracking module 3032, a performance analysis module 3034 and a training program update module 3036. In one embodiment, the motion tracking module 3032 tracks the movement of objects of a video scene during the recording. For example, during a recording of a simulated warfare, where there are a plurality of tanks and fight planes, the motion tracking module 3032 tracks each of these tanks and fight planes. In another embodiment, the motion tracking module 3032 tracks the movement of the participants, especially the arms and hand movements. In another embodiment, the motion tracking module 3032 tracks the retina and/or pupil movement. In yet another embodiment, the motion tracking module 3032 tracks the facial expressions of a participant. In yet another embodiment, the motion tracking module 3032 tracks the movement of the immersion tools, such as the visors and helmets associated with the visors and the cybergloves used by the participants.

The performance analysis module 3034 receives the data from the motion tracking module 3032 and analyzes the received data. The analysis module 3034 may use a video scene playback tool such as the immersive video playback tool illustrated in FIG. 18. For example, the playback tool displays on the display screen the recognized perceptive gestures of a participant with a cognitive queue, such as fast or slow hand gestures, or simple patterns of head movements, or checking behind a person.

In one embodiment, the analysis module 3034 analyzes the data related to the movement of the objects recorded in the video scenes. The movement data can be compared with real world data to determine the discrepancies between the simulated situation and the real world experience.

In another embodiment, the analysis module 3034 analyzes the data related to the movement of the participants. The movement data of the participants can indicate the behavior of the participants, such as responsiveness to stimulus, reactions to increased stress level and extended simulation time, etc.

In another embodiment, the analysis module 3034 analyzes the data related to the movement of participants' retinas and pupils. For example, the analysis module 3034 analyzes the retina and pupil movement data to reveal the unique gaze characteristics of a participant.

In yet another embodiment, the analysis module 3034 analyzes the data related to the facial expressions of the participants. The analysis module 3034 analyzes the facial expressions of a participant responsive to product advertisements popped up during the recording to determiner the level of interest of the participant in the advertised products.

In another embodiment, the analysis module 3034 analyzes the data related to the movement of the immersion tools, such as the visors/helmets and the cybergloves. For example, the analysis module 3034 analyzes the movement data of the immersion tools to determine the effectiveness of the immersion tools associated with the participants.

The training program update module 3036 updates the immersive audio-visual production based on the performance analysis data from the analysis module 3034. In one embodiment, the update module 3036 updates the audio-visual production in real time, such as on-set editing the currently recorded video scenes using the editing tools illustrated in FIG. 17. Responsive to the performance data exceeding a predetermined limit, the update module 3036 may issue instructions to various immersive audio-visual recording devices to adjust. For example, certain actions performed by a participant indicate wariness. Thus, the author of the training scenario can anticipate lulls or rises in a participant's attention span and to respond accordingly, for example, by admonishing a participant to “Pay attention” or “Calm down”, etc.)

In another embodiment, the update module 3036 updates the immersive audio-visual production during the post-production time period. In one embodiment, the update module 3036 communicates with the post-production engine 3040 for post-production effects. Based on the performance analysis data and the post-production effects, the update module 3036 recreates an updated training program for next training sessions.

The post-production engine 3040 comprises a set extension module 3042, a visual effect editing module 3044 and a wire frame editing module 3046. The post-production engine 3040 integrates live-action footage (e.g., current immersive audio-visual recording) with computer generated images to create realistic simulation environment or scenarios that would otherwise be too dangerous, costly or simply impossible to capture on the recording set.

The set extension module 3042 extends a default recording set, such as the blue screen illustrated in FIG. 3A. In addition to replace a default background scene with a themed background, such as a battle field, the set extension module 3042 may add more recording screens in one embodiment. In another embodiment, the set extension module 3042 may divide one recording scene into multiple sub-recording scenes, each of which may be identical to the original recording scene or be a part of the original recording scene. Other embodiments may include more set extension operations.

The visual effect editing module 3044 modifies the recorded immersive audio-visual production. In one embodiment, the visual effect editing module 3044 edits the sound effect of the initial immersive audio-visual production produced by the recording engine 3010. For example, the visual effect editing module 3044 may add noise to the initial production, such as adding loud noise from helicopters in a battle field video recording. In another embodiment, the visual effect editing module 3044 edits the visual effect of the initial immersive audio-visual production. For example, the visual effect editing module 3044 may add gun and blood effects to the recorded battle field video scene.

The wire frame editing module 3046 edits the wire frames used in the immersive audio-visual production. A wire frame model generally refers to a visual presentation of an electronic representation of a 3D or physical object used in 3D computer graphics. Using a wire frame model allows visualization of the underlying design structure of a 3D model. The wire frame editing module 3046, in one embodiment, creates traditional 2D views and drawings of an object by appropriately rotating the 3D representation of the object and/or selectively removing hidden lines of the 3D representation of the object. In another embodiment, the wire frame editing module 3046 removes one or more wire frames from the recorded immersive audio-visual video scenes to create realistic simulation environment.

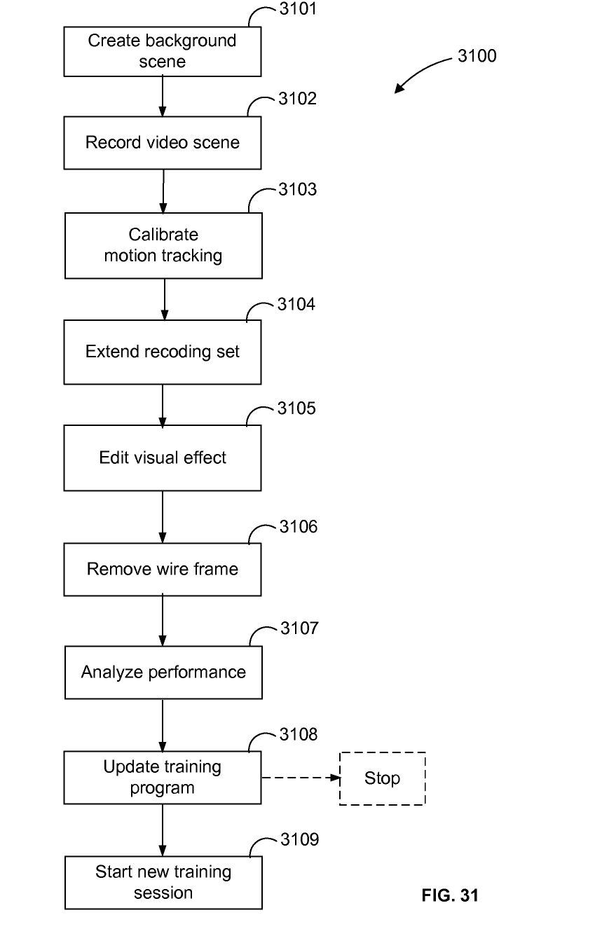

FIG. 31 is a flowchart illustrating a functional view of interactive training system 3000 according to one embodiment of the invention. In step 3101, the system creates one or more background scenes by the background creation module 3012. In step 3102, the system records the video scenes by the video scene creation module 3014 and creates an initial immersive audio-visual production by the immersive audio-visual production module 3016. In step 3103, the system calibrates the motion tracking by the motion tracking module 3032. In step 3104, the system extends the recording set by the set extension module 3042. In step 3105, the system edits the visual effect, such as adding special visual effect based on a training theme, by the visual effect editing module 3044. In step 3106, the system further removes one or more wire frames by the wire frame removal module 3046 based on the training theme or other factors. In step 3107, through the performance analysis module 3034, the system analyses the performance data related to the participants and immersion tools used in the immersive audio-visual production. In step 3108, the system updates, through the program update module 3036, the current immersive audio-visual production or creates an updated immersive audio-visual training program. The system may starts a new training session using the updated immersive audio-visual production or other training programs in step 3109, or optionally ends its operations.

It is clear that many modifications and variations of the embodiment illustrated in FIGS. 30 and 31 may be made by one skilled in the art without departing from the spirit of the novel art of this disclosure. These modifications and variations do not depart from the broader spirit and scope of the invention, and the examples cited here are to be regarded in an illustrative rather than a restrictive sense. Those skilled in the art will recognize that the example of FIGS. 30 and 31 represents some embodiments, and that the invention includes a variety of alternate embodiments.

Other embodiments may include other features and functionalities of the interactive training system 3000. For example, in one embodiment, the training system 3000 determines the utility of any immersion tool used in the training system, weighs the immersion tool against the disadvantage to its user (e.g., in terms of fatigue, awkwardness, etc.), and thus educates the user on the trade-offs of utilizing the tool.

Specifically, an immersion tool may be traded in or modified to provide an immediate benefit to a user, and in turn create long-term trade-offs based on its utility. For example, a user may utilize a night-vision telescope that provides him/her with the immediate benefit of sharp night-vision. The training system 3000 determines its utility based on how long and how far the user carries it, and enacts a cost upon the user of being fatigue. Thus, the user is educated on the trade-offs of utilizing heavy equipment during a mission. The training system 3000 can incorporate the utility testing in forms of instruction script used by the video scene creation module 3014. In one embodiment, the training system 3000 offers a participant an option to participate in the utility testing. In another embodiment, the training system 3000 makes such offering in response to a participant request.

The training system 3000 can test security products by implementing them in a training game environment. For example, a participant tests the security product by protecting his/her own security using the product during the training session. The training system 3000 may, for example, try to breach security, so the success of the system 3000 tests the performance of the product.

In another embodiment, the training system 3000 creates a fabricated time sequence for the participants in the training session by unexpectedly altering the time sequence in timed scenarios.

Specifically, a time sequence for the participant in a computer training game is fabricated or modified. The training system 3000 may include a real-time clock, a countdown of time, a timed mission and fabricated sequences of time. The time mission includes a real-time clock that counts down, and the sequence of time is fabricated based upon participant and system actions. For example, a participant may act in such a way that diminishes the amount of time left to complete the mission. The training system 3000 can incorporate the fabricated time sequence in forms of instruction script used by the video scene creation module 3014.

The training system may further offer timed missions in a training session such that a successful mission is contingent upon both the completion of the mission's objectives and the participant's ability to remain within the time allotment. For example, a user who completes all objectives of a mission achieves ‘success’ if he/she does so within the mission's allotment of time. A user who exceeds his/her time allotment is considered unsuccessful regardless of whether he/she achieved the mission's objectives.

The training system 3000 may also simulate the handling a real-time campaign in a simulated training environment, maintaining continuity and fluidity in real-time during a participant campaign missions. For example, a participant may enter a simulated checkpoint that suspends real-time to track progress in the training session. Due to potential consecutive missions with little or no breaks between in a training program, the training system 3000 enabling simulated checkpoints encourages the participant to pace himself/herself between missions.

To further enhance real-time campaign training experience, the training system 3000 tracks events in a training session, keeps relevant events for a given event and adapts the events in the game to reflect updated and current events. For example, the training system 3000 synthesizes all simulated, real-life events in a training game, tracks relevant current events in the real world, creates a set of relevant, real-world events that might apply in the context of the training game, and updates the simulated, real-life events in the training game to reflect relevant, real-world events. The training system 3000 can incorporate the real-time campaign training in forms of instruction script used by the video scene creation module 3014.

In anther embodiment, the training system 3000 creates virtual obstacles to diminish a participant's ability to perform in a training session by hindering the participant's ability to perform in the training session. The virtual obstacles can be created by altering virtual reality based on performance measurement and direction of attention of the participants.

Specifically, the user's ability to perform in a computerized training game is diminished according to an objective standard of judgment of user performance and a consequence of poor performance. The consequence includes a hindrance of the user's ability to perform in the game. The training system 3000 records the performance of the user in the computer game and determines the performance of the user based on a set of predetermined criteria. In response of poor performance, the training system 3000 enacts hindrances in the game that adversely affect the user's ability to perform.

The virtual obstacles can also be created by overlaying emotional content or other psychological content on the content of a training session. For example, the training system 3000 elicits emotional responses from a participant for measurement. The training system 3000 determines a preferred emotion to elicit, such as anger or forgiveness. The user is faced with a scenario that tends to require a response strong in one emotion or another, including the preferred emotion.

In another embodiment, the training system 3000 includes progressive enemy developments in a training session to achieve counter-missions to the participant so that the participant's strategy is continuously countered in real-time. For example, the training system can enact a virtual counterattack upon a participant in a training game based on criteria of aggressive participant behavior.

To create realistic simulation environment, in one embodiment, the training system interleaves simulated virtual reality and real world videos in response to fidelity requirements, or when emotional requirements of training game participants go above a predetermined level.

In one embodiment, the training system 3000 hooks a subset of training program information to a webcam to create an immersive environment with the realism of live action. The corresponding training grams are designed to make a participant be aware of time factor and to make live decisions. For example, at a simulated checkpoint, a participant is given the option to look around for a soldier. The training system 300 gives decisions to a participant who needs to learn to look at the right time and place in real life situation, such as battle field. The training system 300 can use a fisheye lens to provide wide and hemispherical views.

In another embodiment, the training system 3000 evaluates a participant's behavior in real life based on his/her behavior during a simulated training session because a user's behavior in a fictitious training game environment is a clear indication of his/her behavior in real life.

Specifically, a participant is presented with a simulated dilemma in a training game environment, where the participant attempts to solve the simulated dilemma. The participant's performance is evaluated based on real-life criteria. Upon approving the efficacy of the participant's solution, the training system 3000 may indicates that the participant is capable of performing similar tasks in real-life environment. For example, a participant who is presented with a security breach attempts to repair the breach with a more secure protection. If the attempt is successful, the participant is more likely to be successful in a similar security-breach situation in real-life.

The training system 3000 may also be used to generate revenues associated with the simulated training programs. For example, the training system 300 implements a product placement scheme based on the participant's behavior. The product placement scheme can be created by collection data about user behavior, creating a set of relevant product advertisements, and placing them in the context of the participant's simulation environment. Additionally, the training system 3000 can determine the spatial placement of a product advertisement in a 3D coordinate plane of the simulated environment.

For example, a user who shows a propensity to utilize fast cars may be shown advertisements relating to vehicle maintenance and precision driving. The training system 3000 establishes a set of possible coordinates for product placement in a 3D coordinate plane. The user observes the product advertisement based on the system's point plotting. For example, a user enters a simulated airport terminal whereupon the training system 3000 conducts a spatial analysis of the building and designates suitable coordinates for product placement. The appropriate product advertisement is placed in context of the airport terminal visible to the user.

The training system 3000 can further determine different levels of subscription to an online game for a group of participants based on objective criteria, such as participants' behavior and performance. Based on the level of the subscription, the training system 300 charges the participants accordingly. For example, the training system 3000 distinguishes different levels of subscription by user information, game complexity, and price for each training program. A user is provided with a set of options in a game menu based on the user's predetermined eligibility. Certain levels of subscription may be reserved for a selected group, and other levels may be offered publicly to any willing participant.

The training system 3000 can further determine appropriate dollar changes for a user's participation based on a set of criteria. The training system 3000 evaluates the user's qualification based on the set of criteria. A user who falls into a qualified demographic and/or category of participants is subject to price discrimination based on his/her ability to pay.

Alternatively, based on the performance, the training system 300 may recruit suitable training game actors from a set of participants. Specifically, the training system 3000 creates a set of criteria that distinguishes participants based on overall performance, sorts the entire base of participants according to the set of criteria and overall performance of each participant, and recruits the participants whose overall performance exceeding a predetermined expectation to be potential actors in successive training program recordings.

To enhance the revenue generation power of the training system 3000, the training system 300 can establish a fictitious currency system in a training game environment. The training system 3000 evaluates a tradable item in terms of a fictitious currency based on how useful and important that item is in the context of the training environment.

In one embodiment, the fictitious currency is designed to educate a user in a simulated foreign market. For example, a participant decides that his/her computer is no longer suitable for keeping. In a simulated foreign market, he/she may decide to use his/her computer as a bribe instead of trying to sell it. The training system 3000 evaluates the worth of the computer and converts it into a fictitious currency, i.e., ‘bribery points,’ whereupon the participant gains a palpable understanding of the worth of his/her item in bribes.

The training system 3000 may further establish the nature of a business transaction for an interaction in a training session between a participant and a fictitious player.

Specifically, the training system 3000 evaluates user behavior to determine the nature of a business transaction between the user and the training system 3000, and to properly evaluate user behavior as worthy of professional responsibility. The training system 3000 creates an interactive business environment (supply & demand), establishes a business-friendly virtual avatar, evaluates user behavior during the transaction and determines the outcome of the transaction based on certain criteria of user input. For example, a user is compelled to purchase equipment for espionage, and there is an avatar (i.e., the training system 3000) that is willing to do business. The training system 3000 evaluates the user's behavior, such as language, confidence, discretion, and other qualities that expose trustworthiness of character. If the avatar deems the user behavior to be indiscreet and unprofessional, the user will benefit less from the transaction. The training system 3000 may potentially choose to withdraw its offer or even become hostile toward the user should the user's behavior seem irresponsible.

To alleviate excessive anxiety enacted by a training session, the training system 3000 may alternate roles or viewpoints of the participants in the training sessions. Alternating roles in a training game enables participants to learn about a situation from both sides and what they have done right and wrong. Participants may also take alternating viewpoint to illustrate cultural training needs. Change of viewpoints enables participants to see themselves or see the viewpoints from the other persons' perspective after a video replay. Thus, a participant may be observed in a first-person, third-person, and second-person perspective.

The training system 300 may further determine and implement stress-relieving activities and events, such as offering breaks or soothing music periodically. For example, the training system 3000 determines the appropriate activity of leisure to satisfy a participant's need for stress-relief. During the training session, the participant is rewarded periodically with a leisurely activity or adventure in response to high-stress situations or highly-successful performance. For example, a participant may be offered an opportunity to socialize with other participants in a multiplayer environment, or engage in other leisurely activities.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims of this application. As will be understood by those familiar with the art, the invention may be embodied in other specific forms without departing from the spirit or essential characteristics thereof. Likewise, the particular naming and division of the modules, routines, features, attributes, methodologies and other aspects are not mandatory or significant, and the mechanisms that implement the invention or its features may have different names, divisions and/or formats. Furthermore, as will be apparent to one of ordinary skill in the relevant art, the modules, routines, features, attributes, methodologies and other aspects of the invention can be implemented as software, hardware, firmware or any combination of the three. Also, wherever a component, an example of which is a module, of the invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the invention is in no way limited to implementation in any specific programming language, or for any specific operating system or environment. Accordingly, the disclosure of the invention is intended to be illustrative, but not limiting, of the scope of the invention, which is set forth in the following claims.

What is claimed is:

1. A computer method for producing an interactive immersive video for an audio-visual production system having one or more of cameras and microphones, the method comprising:
creating a background scene for the interactive immersive video;
recording one or more immersive video scenes using the background scene and the cameras and the microphones, an immersive video scene comprising one or more participants and immersion tools;
receiving one or more interaction instructions; and
rendering the immersive video scenes based on the received interaction instructions to produce the interactive immersive video.

2. The method of claim 1, further comprising selecting a view of one of the immersive video scenes in response to a participant's head movement.

3. The method of claim 1, further comprising playing back the video scenes.

4. The method of claim 1, further comprising editing the immersive video scenes.

5. The method of claim 4, wherein editing the immersive video scenes is a real-time editing.

6. The method of claim 3, wherein editing the immersive video scenes is a post-production editing.

7. The method of claim 1, wherein recording the immersive video scenes comprises motion tracking at least one of a group of movement of objects in the immersive video scenes, movement of one or more participants, and movement of the plurality of immersion tools.

8. The method of claim 7, wherein motion tracking of a participant comprises:
tracking the movement of the participant's arm and hands;
tracking the movement of retina or pupil of the participant; and
tracking the facial expressions of the participant.

9. The method of claim 1, wherein the plurality of the cameras are arranged according to a dioctographer configuration for recording 2×8 views.

10. The method of claim 1, wherein one or more of the plurality of the cameras are super fisheye cameras.

11. The method of claim 1, wherein one of the immersion tools is an immersive visor associated with at least one of the participants.

12. The method of claim 1, further comprising filtering the interactive immersive video according to one or more video formats.

13. The method of claim 1, further comprising calibrating one more soundscapes with the immersive video scenes, a soundscape being associated with an immersive video scene of the immersive video scenes.

14. A computer system for producing an interactive immersive video for an audio-visual production, the system comprising:
one or cameras and microphones;
a background creation module configured to create a background scene for the interactive immersive video;
a video scene creation module configured to record one or more immersive video scenes using the background scene and the cameras and the microphones, an immersive video scene comprising one or more participants and immersion tools;
a command module configured to receive one or more interaction instructions; and
a video rendering module configured to render the immersive video scenes based on the received interaction instructions to produce the interactive immersive video.

15. The system of claim 14, further comprising a view selection module configured to select a view of the immersive video scenes in response to a participant's head movement.

16. The system of claim 14, further comprising a playing back module configured to play back the video scenes.

17. The system of claim 14, further comprising a video editing module configured to edit the immersive video scenes.

18. The system of claim 17, wherein the video editing module is configured to edit the immersive video scenes in real time.

19. The system of claim 17, wherein the video editing module is further configured to edit the immersive video scenes at a post-production phase.

20. The system of claim 14, wherein the video scene creation module is further configured to track at least one of a group of movement of objects in the immersive video scenes, movement of one or more participants, and movement of the immersion tools.

21. The system of claim 20, wherein the video scene creation module is configured to:
track the movement of the participant's arm and hands;
track the movement of retina or pupil of the participant; and
track the facial expressions of the participant.

22. The system of claim 14, wherein the cameras are arranged according to a dioctographer configuration for recording 2×8 views.

23. The system of claim 14, wherein one or more of the cameras are super fisheye cameras.

24. The method of claim 1, wherein one of the immersion tools is an immersive visor associated with at least one of the participants.

25. The system of claim 14, further comprising one or more resource adapters configured to filter the interactive immersive video according to one or more video formats.

26. The system of claim 14, wherein the video scene creation module is configured to calibrate one or more soundscapes with the immersive video scenes, a soundscape being associated with an immersive video scene of the immersive video scenes.
